(19) United States
(12) Patent Application Publication
(10) Pub. No.: US 2015/0072791 A1
(43) Pub. Date: Mar. 12, 2015

(54) SYSTEMS AND METHODS FOR AN INTERNET COMPETITION NETWORK

(71) Applicant: DIONICIO MELCHOR BATISTA JEREZ, Santo Domingo Oeste (DO)

(72) Inventor: DIONICIO MELCHOR BATISTA JEREZ, Santo Domingo Oeste (DO)

(21) Appl. No.: 14/023,576

(22) Filed: Sep. 11, 2013

(51) Int. Cl. A63F 13/30

(52) U.S. Cl. CPC A63F 13/12
USPC 463/42

(57) ABSTRACT

A service that allows collecting, process and sharing data about any activity in which one or more beings compete. Human, Organization or Robot users using any connected device are provided with a centralized profile where they can view their data, challenge other users and judge or be judged by other users. The service also allows users to add all means they use to compete as Dependent members such as Animals, Plants, Vehicles, Humans, Teams or Tools. The service also provides means to create activities with custom Data types, Formulas, Ranking systems and Top competitor selection criteria as a representation of an existing live or virtual activity; or modify preexisting templates to adapt them to his needs. Relationships between members are automatically assigned based on operations members do. Users can also compare two or more elements of the network or just follow other members by receiving constant updates about them.

### CROSS REFERENCE TO RELATED APPLICATIONS

U.S. Ser. No. 13/729,157: SYSTEMS AND METHODS FOR AN INTERNET COMPETITION NETWORK
U.S. Ser. No. 13/374,412: INTERNET COMPETITION NETWORK
U.S. 61/631,150: SYSTEMS AND METHODS FOR DEFINING USER CUSTOM RANK SYSTEM ON AN INTERNET COMPETITION NETWORK OR SOCIAL NETWORK
U.S. 61/631,144: SYSTEMS AND METHODS FOR SEARCHING ON AN INTERNET COMPETITION NETWORK
U.S. 61,631,145: SYSTEMS AND METHODS FOR DYNAMICALLY COMPARING GEOGRAPHIC REGIONS BASED ON DATA OF AN INTERNET COMPETITION NETWORK
U.S. 61/631,147: SYSTEMS AND METHODS FOR DEFINITION OF A CUSTOM COMPETITION ACTIVITY ON AN INTERNET COMPETITION NETWORK OR SOCIAL NETWORK
U.S. 61/631,146: SYSTEMS AND METHODS FOR DEFINITION OF CUSTOM FORMULAS FOR AN INTERNET COMPETITION NETWORK ACTIVITY ON AN INTERNET COMPETITION NETWORK OR SOCIAL NETWORK.
U.S. 61/631,148: SYSTEMS AND METHODS FOR CHALLENGE MANAGING BETWEEN USERS OF AN INTERNET COMPETITION NETWORK OR SOCIAL NETWORK
U.S. 61/631,149: SYSTEMS AND METHODS FOR DYNAMICALLY CALCULATING USER REPUTATION ON AN INTERNET COMPETITION NETWORK OR SOCIAL NETWORK.
U.S. 61/631,152: SYSTEMS AND METHODS FOR DYNAMICALLY GENERATING INTERNET COMPETITION NETWORK USER PROFILES
U.S. 61/631,151: SYSTEMS AND METHODS FOR COMPETITION EVENT MANAGEMENT ON AN INTERNET COMPETITION NETWORK OR SOCIAL NETWORK

### BACKGROUND OF THE INVENTION

Species have competed since the beginning of time for food, mating or survival. Unlike other living species most of the modern human competition activities are for fun, recreation or personal growth. With the exception of war which is the highest level of competition, most of the modern competition activities are designed to cultivate the human body, using the body as a competition element or competing alongside with other means like vehicles, animals or tools.

One particular problem is that most of the data generated by actual competition activities like amateur sports, beauty contest, farm fairs or paint contest are not recorded or taken into account by actual social networks. This leads to the situation where each organization that wants to promote their members records and achievements have to develop and maintain a separate website, making the data of a particular activity dispersed and disorganized.

Data on small organized networks like videogames are segregated due to competition between companies. Users who have more than one console or mobile device don't have a central place to see the data and achievements they generate on networks like Xbox Live, PlayStation network or BattleNet.

Sports social networks are still tied to the Social network model requiring the users to join and post their data without means of validation from the organization they belong. Those networks are in their majority followers of big sports activities giving their members only the information from well-established sports and teams and not from their local communities. Another drawback of the Sports social networks is that they lack a tool where the users can create their own sports or recreational activities, forcing the users to choose from a set of predefined activities from well-known sports with few choices for modification or customization.

Second, there is a need for recreational institutions or little sports leagues like little league baseball, football or amateur soccer for a centralized tool to keep and maintain current and historical data about their members to impact their local community. The lack of resources or knowledge is leading that well established sports are getting almost all the attention from the fans.

The adaptation and following of rules when a small organization joins a regional, national or international organization also presents difficulties when maintaining their websites. Many sports and recreational organizations have little variations of the rules depending on geographical region, age or staff preferences.

Another limitation is that most of the current networks are constructed based on what users like, not on what they do or have; making difficult for users who share a common activity to find each other, share experiences or to team up. It is said that many people like baseball or football but not all of them practice those sports.

Examples of operations that users can't make on actual social networks are:
a) Find Photographers who live in Boston and have a Canon 7D DSLR and invited them to a photo safari.
b) Find Hip Hop dancers that graduated at Olmsted Performing Arts dance Academy and invite them to a dance contest.
c) Find a female singer, a drummer and two guitars players and contact them to form a rock band.
d) Find all 2011 Chevrolet Camaro owners from Florida and contact them to form a Camaro owner's club.
e) Find and contact a female British Bulldog owner from The Bronx, N.Y. to ask for assistance and recommendations
f) Find golf players who live in Toronto, Canada and have a handicap of 10 and invite them to participate in a golf tournament.
g) Compare two geographic regions based on competition or activities data.
h) Vote as “Dislike” or rate as 1 to 5 stars on people, topics or organizations
i) Vote daily as a fan for one of the participants of a beauty contest.

Rare competition activities have little or no support on the web, making them difficult to be discovered by other people in their local communities. Competitors of math tournaments, mustache contest, extreme sports or garden contest rarely see their data or achievements on the web. In most cases even if a small organization has their website, data about competition events is disorganized and is not maintained with time. This is causing that in most cases a web site visitor can't see the winners from previous years.

On the other hand most social networks require that users must declare a close relationship with other users to allow them to interact. Users are forced to declare their teachers, trainers, mentors, roommates and teammates as friends even if they're not considered as such by the users.

Other main limitation of the current networks is that their design is specifically for connecting people; animals, pets, plants, vehicles, gadgets and tools are out of their operational model. Animals in some cultures are considered as part of the family and people love to talk and share information about their pets. On the other hand people who have some tool, vehicle or gadget find it difficult to find and associate with others because they lack a tool to find people based of what they have. Lots of people like a Chevrolet Camaro, but even fewer people have a Chevrolet Camaro.

One big obstacle for actual networks is that COPPA (Children Online Privacy Protection Act) law established that websites who directly collect information from their children must have a written content from their parents if the child is younger than 13 years of age, making it difficult to collect competition data from underage people. Also the before mentioned law requires that websites must physically delete at parent request all data that could lead to directly contacting the child, making it difficult to design with databases that can support orphan data.

Also talent seekers lack a tool to compare talented competitors (men, animals, machines or tools) from different geographic regions, disciplines and ages, by using their own search methods, formulas or calculation criteria to compute raw data the way they want.

The lack of and administration tool where a person can direct and administer all aspect of a competition or recreational activity is preventing that nonprofessional sports organizations from posting their information to the internet. In addition most of the professional organizations lack a tool for posting historic data from each member, leaving that data on paper sheets on files in their offices, causing historic information on competition and recreational activities to disappear with time because of the deterioration of those sheets.

Other organizations have spreadsheets to manage their data, which in the long run can cause data loss due to the lack of backup procedures, or it could be tedious to maintain data structure and rules when new data is added each year.

Therefore a new type of network must be established with a total differentiation from social networks and with its own set of rules, user types, member interactions, activities, user policies and the addition of other non-human elements such animals, plants, vehicles or tools.

### SUMMARY OF THE INVENTION

The invention is comprised by systems and methods to allow internet connected users to record, evaluate and maintain data related to virtual or live activities. All data related to a User, Organization, Competitor or Dependent is concentrated into a single profile allowing users to have all their activities in one place. Any profile can be followed by users in the network having the “Follower” user role. Users with elevated privileges can create activities on the network with their own custom set of data types, rules and ranking systems to mimic any virtual or live activity. Users can also add dependent profiles which can accommodate data about all means they use to compete such as animals, plants, tools, gadgets, vehicles, humans, organizations or teams. Also follower users can subscribe to receive continuous up to date information about other users, competitors, organizations, dependents, events or activities.

Internet enabled services are provided to allow a group of users such as people, organizations or artificial intelligences to connect, follow and compete between them. The system can also be used by users to store data about live or virtual competition activities or events. The system receives its configuration parameters formulas for statistics calculation, preferences for ranking, top competitor criteria, user roles and privileges from one or more databases located on one or more servers. Parameters can be predefined to mimic well known competition activities like baseball or football or can be created from scratch by users with elevated privileges (Commissioner Role) to mimic any virtual or live activity. Also users are provided with templates with data, rules and ranking systems of most popular sports and competition activities which they can modify and adapt to their needs.

Using any internet connected device such as cellphones, smartphones, tablets, laptops, desktop computers, video game consoles, portable video game consoles, smart TVs or PDAs one or more users can connect to a central or distributed server farm. Operations on this server farm are performed on multiple servers such as web servers, database servers, application servers, mobile app servers, backup servers, security servers or load balancing servers.

Information in the network can be stored on both SQL and No-SQL databases. Information in the database is comprised of but not limited to general information on each user such as name or email, general or detailed data about competition activities and roles that users have in the network. Users can have one or more roles in the network. User roles govern what users can do or see in the network.

Members relate or interact with others based on his competition data; members can then have conversations if they belong to the same team or organization or if they compete against each other in an event. In an Internet Competition Network there is no such thing as friend request, family request or discussion groups. Users interact with each other using automatically assigned competition driven relationships such as teammate, roommate, mentor, colleague, rival or opponent.

User roles governs what users can do or see in an Internet Competition Network, those roles can comprise:
a) Follower: follows other users, organizations, teams, dependents, and events.
b) Competitor: competes on events, can challenge other competitors
c) Arbiter: Validates events and certify data
d) Commissioner: Creates and administer activities, invites to events
e) Scout: Can search for talented competitors to propose a contract or offer.
f) Sponsor: Can create activities and events related to his brand or name.
g) Annotator: Enters or capture competition data on an event
h) Administrator: Administers the network, reserved for employees of the company who runs the network.

For the sake of comprehension from now on when we mention a user having or using a specific role it will be named with the name of the role followed by the word “User” or “Users”.

All members of the network such as humans, organizations, teams, plants, gadgets, or tools can also be evaluated based on their participation on events by a reputation system; the reputation system can calculate reputation by won, lost or disqualification, but other actions can lower the reputation like not attending to a previously confirmed event.

Competitor users can set preferences based on reputation; an example could be a user not accepting challenge request from other users with reputation lower than 90%; however not accepting certain number of challenge request can also lower the reputation of the user.

Arbiter users are also governed by the reputation system; in that manner the decision of an arbiter can be impugned by participating users on the event he judged, disputes are then solved by the user who is in charge of the activity (Commissioner User). Not attending to events and the total of “dislikes” votes he receives can lower his reputation. When attending to an event, competitors can see the arbiters and their reputation, and are also able to propose another arbiter in case the reputation the arbiters does not meet the expectations.

User interaction on an Internet Competition Network can be initiated or terminated by sending requests such as:
a) Team request: invitation to associate two or more users to forma team
b) Mentor request: request asking for assistance or tutorship
c) Scout request: Request directed to a Commissioner user to see and evaluate data related to his activity.
d) Challenge request: Invitation directed to one or more Competitor users asking them to participate in an event.
e) Arbiter request: Invitation to attend, evaluate and certify data of an event.
f) Revoke request: directed to an Arbiter or Commissioner user to review or reevaluate the results of an event, award, record or achievement.
g) Link request: directed to a Commissioner user from a Competitor to link all data related to the first; After this request is accepted all data related to the Competitor is shown in his profile
h) Organizational request: Invitation from an organization to a superior organization to be accepted as a member.
Appeal request: directed to a Commissioner or Arbiter user to reconsider a decision.
Delete request: a special request from a parent to a Commissioner user asking to delete all data that can lead to contact an underage child directly.

The network also allows organizations to add their members by creating standalone profiles that can be linked to users later on. In that sense a competitor can be part of the network without being an active user.

Because an email or other personal information is not required to subscribe to the network underage children can subscribe freely with just entering a username and their age. Further operations the user can do or see are then allowed taking the specified age into account. This model does not directly collect personal information about underage children or any information than can lead to contact the child. Directing or staff members can add standalone profiles by registering general information about those children as they had on paper. Underage children and their parents can view their managed profiles with the same consent they gave by taking the child and registering in the organization.

Also to comply with COPPA regulations parents can send a “Delete request” to a Commissioner user on any activity, in this case the Commissioner user is obligated to delete all personal information about the child. If the Commissioner user does not respond to the request in a reasonable time frame then Administrator users can take action to attend to the parent request and comply with COPPA regulations, sending an admonition message to the Commissioner user for not responding to the parent request. Failing to answer several delete request from parents can cause the Commissioner user to lose his role, and his activity can be cancelled or deactivated.

When a “Delete request” is answered by a Commissioner user or Administrator user all personal information of the user profile is physically deleted from the database and the username is named “Deleted user” or “Deleted competitor”, however all data related to competition events, awards and interaction are not deleted to maintain data consistency. A unique identifier or “ID” will be used to identify the user profile and prevent orphaned data. This ID is sent via email to the parents with information on how to reestablish the profile and reconnect the data in case they change their minds or the child grows and decide to join the network by himself.

The network also allows users to add as “Dependent” all means they use to compete such as animals, plants, tools, vehicles, gadgets or teams. Those dependents can compete along with the user or in his name. Each dependent has his separate profile an can be followed by users; in this manner Follower users can receive continuous updated information about a talented dog, a special vehicle or a team of people who are dependents of a coach or manager.

Some activities in the network could require that members need to have a certain dependent with specific characteristics in order to participate in events. In this manner a mountain bike activity could require a bike with specific properties, a golf players club could require a specific handicap or a Desert Rally club could require the appliers to have an Hummer H3 SUV or a Harley Davidson motorcycle to be accepted as members.

When invited to an event where dependent competitors will be used, all attending Competitor users can view profiles of other attending competitors and their dependents. In that manner by example all attending competitors to a paint ball competition can see the weapons each other will use.

The network also provides means to compare any member of based on their competition data and other public available data. Other comparison options are like or dislike votes or 1 to 5 star rating. Users can view and compare any element of the network based on geographic regions or other criteria or activity and see how they was ranked on previous years.

### BRIEF DESCRIPTION OF THE DRAWINGS

The previous summary, as well the following detailed description of the invention is better understood when read in conjunction with the appended drawings. For the purpose of illustrating the invention, there is shown in the drawings exemplary diagrams that illustrate the information flow, user roles, database entities and access rights; however, the invention is not limited to the specific methods and instrumentalities disclosed in the drawings.

FIG. 1 is a block diagram showing the internet network environment where the invention may be implemented.

FIG. 2 is a block diagram showing user types, roles and dependents members. The diagram also shows the roles and dependent members that each type of user can have and the elements that can be grouped to form a team.

FIG. 3 is a block diagram showing the database entities, user roles and access types.

FIG. 4 is a block diagram showing the data definition, formulas, statistics, raw data, data rules and user generated profile data entities in a database engine.

FIG. 5 illustrates the creation of a competition activity on a user profile.

FIG. 6 is another illustration showing the creation of activity data types, rules and references on a user profile.

FIG. 7 is another illustration showing the process of creating formulas in a competition activity.

FIG. 8 illustrates the rank definition process of an activity in a user profile.

FIG. 9 illustrates the top competitor criteria definition of an activity on a user profile.

FIG. 10 illustrates how to send challenge request on a user profile

FIG. 11 illustrates pending challenge request on a user profile

FIG. 12 illustrates pending arbiter request on a user profile.

FIG. 13 illustrates a list of activities on a user profile with the reputation for each one represented by a percentage number

FIG. 14 illustrates small colored screen portions with a summary of the user's generals plus his reputation known as a mini-profile.

FIG. 15 illustrates a list of activities in on a user profile in which a he can see his rank and reputation represented by a percentage number.

FIG. 16 illustrates a list of activities on an Arbiter user profile with the reputation for each activity represented by a percentage number.

FIG. 17 illustrates a summary of statistics and awards by activity on a Competitor user profile.

FIG. 18 illustrates a list of awards on a user profile.

FIG. 19 illustrates a list of dependent profiles on a user profile

FIG. 20 illustrates a dependent member profile on a user profile

FIG. 21 illustrates a live event annotation or data entry operation by an Annotator or Arbiter user.

FIG. 22 illustrates a virtual event, a discrete math tournament with real time evaluation.

FIG. 23 illustrates a following section screen of an event on a user profile.

FIG. 24 illustrates the results of a live single event and the chat session between competitor users who attended.

FIG. 25 illustrates a single elimination tournament in a follower user profile.

FIG. 26 illustrates the results of a beauty contest event on a user profile.

FIG. 27 illustrates two round robin tournaments following section on a user profile.

FIG. 28 illustrates a search operation with options and filters.

FIG. 29 illustrates a comparison between two geographical regions based on competition data generated in the network and other public available data.

FIG. 30 shows comparison charts between several elements, showing public data from other sources combined with reputation and user rating from the competition network.

### DETAILED DESCRIPTION OF THE INVENTION

### A) Field of the Invention

This invention generally relates those activities in which beings compete between each other; those beings can be living organism like humans or animals, virtual intelligences or robots or legal persons like organizations or teams. Those activities can be either live if is taking place in the physical world or virtual if is taking places in a computer generated virtual world. In particular this invention is directed to live and virtual competition activities such as sports, contest or videogames.

This invention also relates to internet connected networks, web services and particularly to systems and methods to allow internet connected users to record data about live or virtual competition activities, define their own by adding data definitions and formulas to mimic any live or virtual competition activity and add all means they use to compete such as animals, plants, vehicles or tools.

The invention also relates to web services and technologies to allow non-competing users to follow or stay in touch by receiving continuous up to date information about users, organizations or dependents members (animals, plants, vehicles or tools) they're interested in.

The invention also relates to systems and methods to compare two elements of the network based on internal data from one or more databases. This comparison can also be complemented with public available data. The comparison system can determine the winner automatically by analyzing the data and the rules containing them.

The invention is also related with systems and methods to allow users with elevated privileges to create one or more custom set of formulas and data definitions to manage the data they're in charge of; or creating custom reports with their own formulas and process steps to view the data the way they want. Only users with the Commissioner, Sponsor or Scout roles can create said custom reports.

### B) Detailed Description:

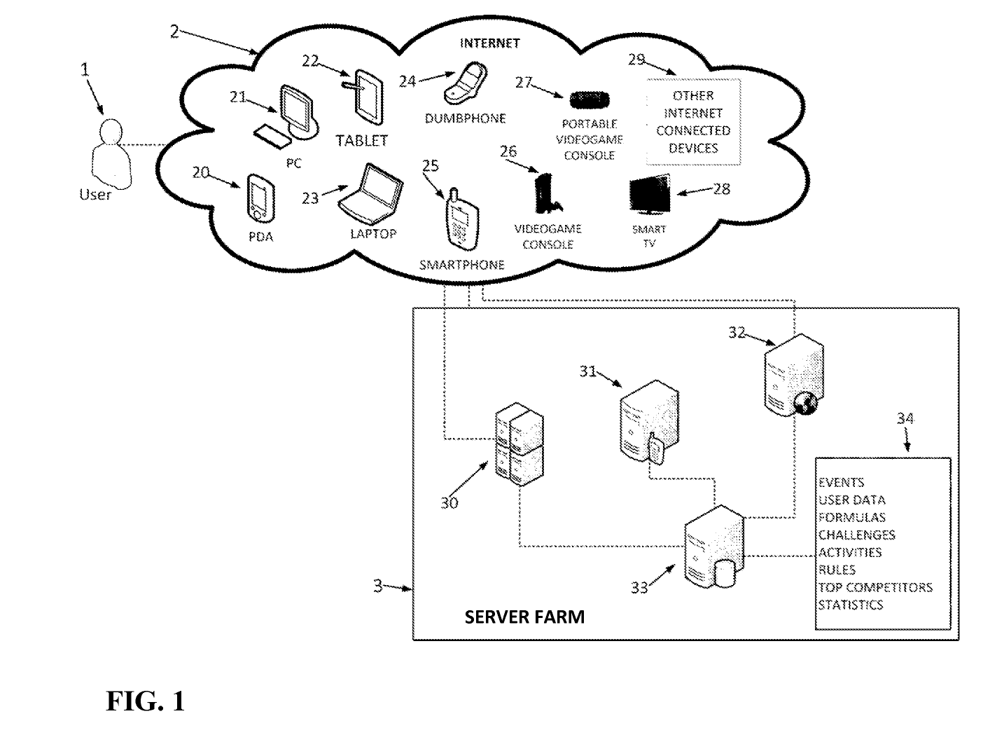

FIG. 1 is a diagram showing the internet structure where the invention is implemented. Here a user 1 connects to one or more services of the network through the internet cloud 2 using one or more internet connected devices 20-29. One or more server farms 3 are responsible of those services, the server farm can comprise of one or more Application servers 30, Mobile Application servers 31, Web servers 32, or Database servers 33. Other servers can be added to the server farm to cover support operations such as load balancing, backup or firewalling.

The user 1 can be a human, an Organization or an Artificial intelligence (robot), the user can access the services of the network by using a Portable computer or PDA 20, a desktop PC 21, a Tablet computer 22, a Laptop computer 23, a Dumb phone 24, a Smartphone 25, a Videogame console 26, a Portable videogame console 27, a Smart TV 28 or other device that can connect to the internet cloud 2.

Server farms 3 can be located on a single geographical region or distributed across multiple regions for load balancing purposes. The Server farms 3 can be comprised of one or more Application server 30, Mobile Application server 31, Web server 32 or Database server 33 to cover the demand of information from the users.

Application servers 30 provide connection services and perform calculations to send the results to connected devices 20-29 through the internet cloud 2.

Mobile Application servers 31, provides connection and services for applications running on devices 20-29 connected to the internet cloud 2, applications or Apps on internet connected devices 20-29 then perform the calculations by themself.

Web servers 32 are responsible for providing connection and services to web browsers running on internet connected devices 20-29.

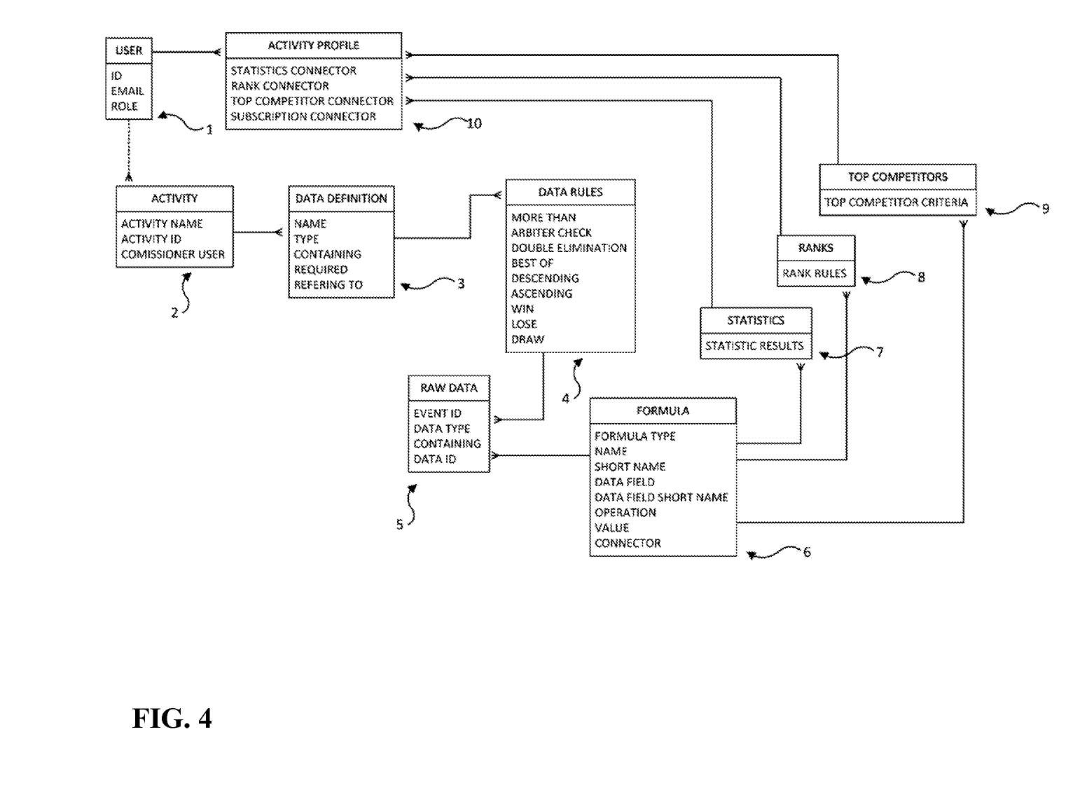

One or more Database servers 33 store data and send by demand elements of information 34 to other servers 30-33 such as: Events, User data, Formulas, Challenge requests, Activities, Rules, Top Competitors or Statistics FIG. 4.

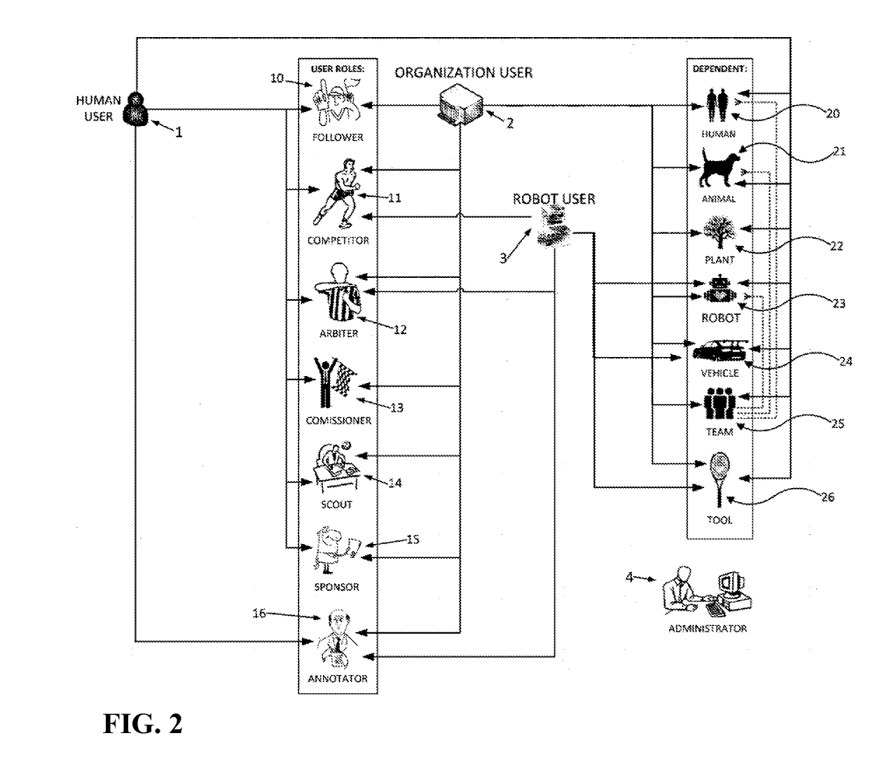

FIG. 2 is a diagram showing the user roles related to each user type and the dependents each user can have. Three types of users 1-3 can subscribe to the network to perform operations and a fourth type of user 4 that perform administrative tasks and enforce user policies of the company that runs the network.

A Human user type 1 is used by a living person who can access the network through an internet enabled device FIG. 1 20-29. A Human user can have one or more user roles such as: Follower 10, Competitor 11, Arbiter 12, Commissioner 13, Scout 14, Sponsor 15, or Annotator 16. Also Human users can have one or more dependent members such as: Humans 20, Animals 21, Plants 22, Robots 23, Vehicles 24, Teams 25, or Tools 26.

An Organization User 2 can be used by one or more members of the organization to connect and perform operation in its name. An Organization user 2 can have one or more roles such as: Follower 10, Competitor 11, Arbiter 12, Commissioner 13, Scout 14, Sponsor 15 or Annotator 16. Also Organization users 2 can have one or more dependent members such as: Humans 20, Animals 21, Plants 22, Robots 23, Vehicles 24, Teams 25 or Tools 26.

A Robot user 3 is an artificial intelligence that can be permanently logged to the network or can be connected by a limited time. Robot users 3 can be programs or games that other users can challenge or compete against, or can be software attached to physical devices to compete in live events. Robots users 3 have limited roles such as: Competitor 11, Arbiter 12 or Annotator 16. Also Robot users 3 can only have as dependent members other Robots 23, Vehicles 24 and Tools 26.

The Administrator user type 4 is a special user who works for the company that runs the network. His main task is to ensure data consistency, resolve technical problems and ensure all server infrastructure is working as planned. Also Administrator users 4 can solve disputes between users and can take action against any person, user, organization, activity or event that violates company rules or user agreements.

Like any other network they are regulations that govern user types, the roles or the type of dependent the users 1-3 can have in the network such as:
a) Users 1-3 can't have both Competitor 11 and Arbiter user roles in the same event, with the exception of Robot users 3.
b) A Robot user 3 can't have living beings as dependent members such as: Humans 20, Animals 21, or Plants 22.

Dependent members 20-26 are those means the users 1-3 use to compete along with or in their name, such as: Humans 20, Animals 21, Plants 22, Robots 23, Vehicles 24, Teams 25, or Tools 26. There are cases when users 1-3 can become dependents of other users, e.g.: when a Human user 1 joins an Organization 2, or when an Organization 2 builds a Robot 3. In that sense another example of dependent members can be a baseball team where all players have their Human user account 1, but also are dependents of an Organization 2 (the team) which is also dependent of a Coach who has another Human user account 1.

Human dependent members 20 are human beings who could be an active user or not. This dependent member type is designed for young humans like babies, underage children, people who don't know how to use internet connected devices FIG. 1 20-29 or those who don't want to be an active member in the network. This type of membership is also reserved for those humans that compete in the name of others humans or organizations.

Animal dependent members 21 are faunal living beings that are used to compete in the name of the users 1-3 or alongside them.

Plant dependent members 22 are floral living beings that are used to compete in the name of the users 1-3 or alongside them.

Robot dependent members 23 are artificial intelligences that are attached to physical devices or are deployed in computer environments. Those intelligences can compete in the name of the users 1-3 or alongside them.

Vehicle dependent members 24 are devices that can move themselves from one point to another. Those vehicles can be used by users 1-3 to compete along with them or in their name.

Team dependent members 25 are groups of Vehicles 24, Robots 23, Animals 21, Humans 20 or any combination of them that can be used by users 1-3 to compete along with them or in their names.

Tool dependent members 26 are those gadgets that users 1-3 use to compete; a tool is a device that cannot compete by itself.

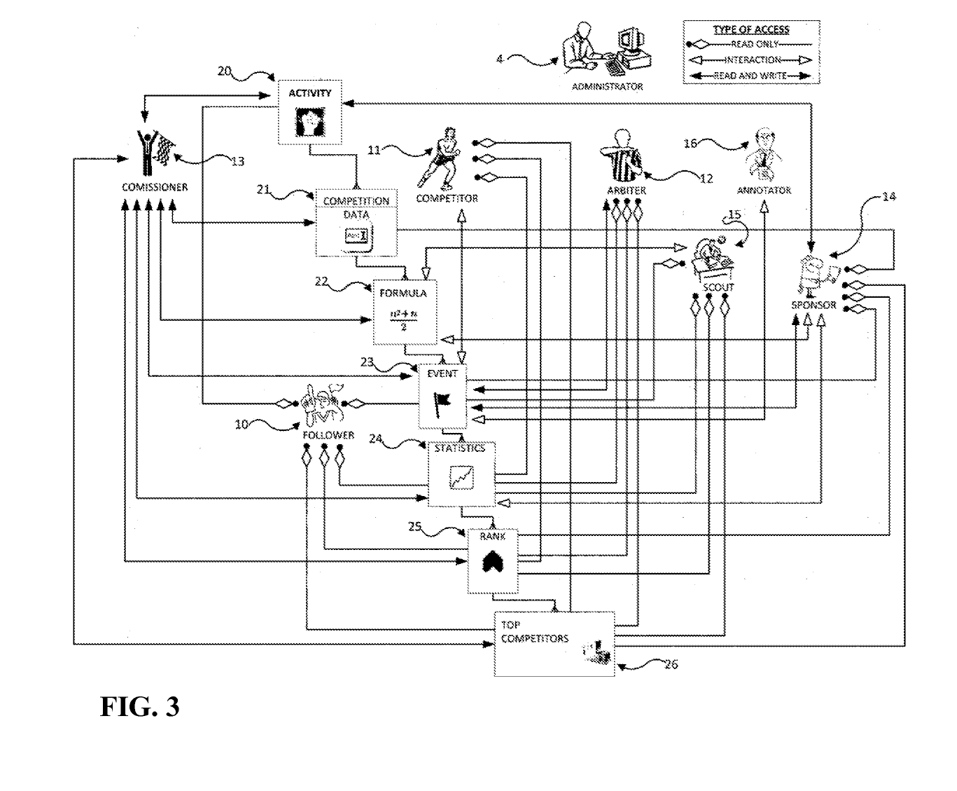

For the sake of comprehension from now on when describing a user using one user role to do an operation will be named by the Role followed by the word “user” or “users” e.g.: When a Human user FIG. 2:1 uses the Commissioner role FIG. 3:13 to do an operation, it will be named as “Commissioner user”.

FIG. 3 is a conceptual diagram showing the main database entities and the access rights users FIG. 2:1-3 can have according with their role FIG. 2:10-16. There are three main type of access:
a) Read only: users can only see data the way it was predefined by Commissioner 13 or Sponsor 14 Users.
b) Interaction: users can enter data and do some operations. Those operations are governed by formulas and rules previously defined by Commissioner 13 or Sponsor 14 users.
c) Read and write: users can change data, rules and formulas.

Database entities 20-26 are those logically separated spaces in the memory of one or more database servers FIG. 1:33 that are designed to store data, formulas, rules and other definitions for future retrieval, calculus or to be used as a guide for one or more processes.

The Activity database entity 20 contains the main information about those topics in which competitors can compete in the network. Specifying main activity data is the first step in the competition creation process.

The competition database entity 21 contains data types, validation rules, references to other data types and default values. This data definition entity controls what information can be stored in an activity and how is validated.

The formula database entity 22 contains instructions on how to calculate data stored in the Competition data entity 21. Those instructions can be for data grouping, summarization, mathematical operations or comparison between elements of the Competition database entity 21.

The Event database entity 23 is the repository for storing and retrieving data about Activity 20 occurrences. Each occurrence of an Activity 20 can have one or more Events 23 occurrences. Therefore for each occurrence of an Event 23 all Activity 20 definitions, Competition data 20 definitions and calculation Formulas 22 are applied. All Events 23 conserve all definitions and formulas for each occurrence for data consistency, in that sense a change of Competition data 21 or Formula 22 database entities won't affect past Events 23.

The Statistics database entity 24 is the result of calculations of the data stored in the Event 23 database entity and the application of one or more formulas stored in the Formula 22 database entity. This entity stores the results of those calculations to serve as cache for the servers FIG. 1:30-32 reducing wait time for other calculation operations.

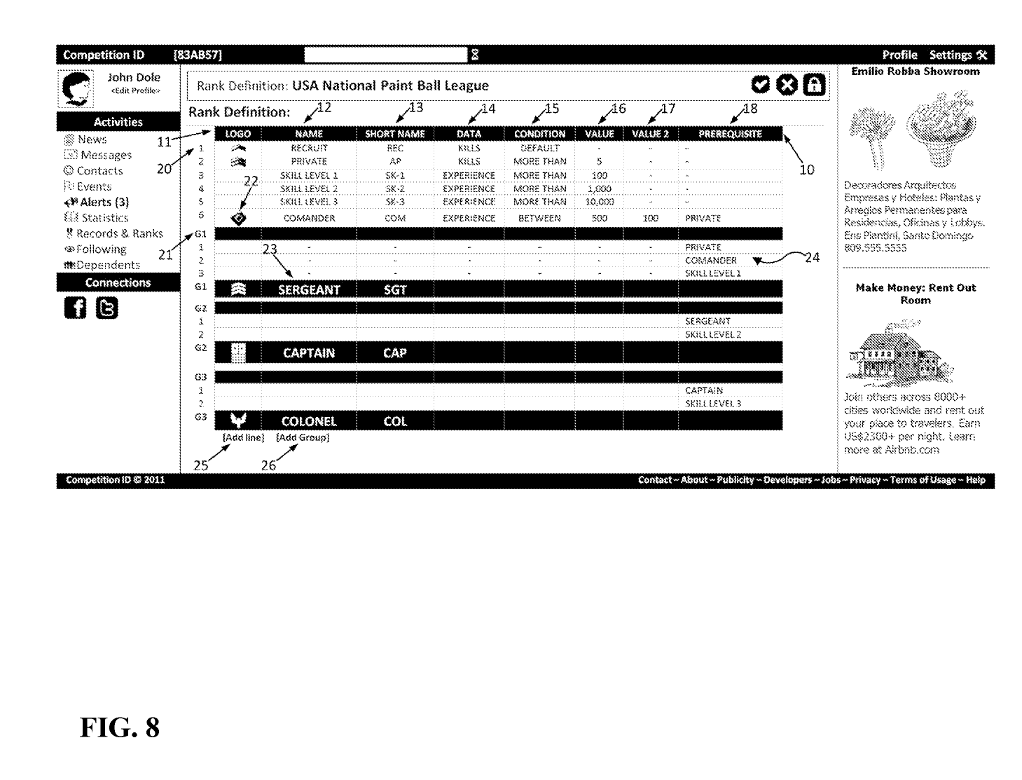

The Rank database entity 25 contains rules and formulas that are used to reward competitors with one or more distinctions when their statistics reaches some point or a rule is applied. Users FIG. 2:1-3 and dependent members FIG. 2:20-26 can have one or more ranks applied to their profile FIG. 8. Also the Ranks database entity 25 conserves each instance when a ranking rule is applied, in that manner previous ranks applied to users or dependent members can be preserved.

The Top Competitor database entity 26 contains rules to determine the best Competitors 11 of one or more Activities 20. Top competitors can show awards as achievements in their generated profiles FIG. 4:10. Rules can be arranged in one or more time cycles so top competitors can be determined in a periodic way. Each time a top competitor is determined by the rules a new instance is created so Competitors 11 can retain their past awards.

Based on de definition of the database entities 20-26 and the type of access operations users can perform in the network having an specific role 11-16 can be as follow:

The Follower user role 10 is designed for noncompetitive task. This role allows a user to subscribe to one or more elements in the network and receive up to date information about those elements of his interest. Operations that users can perform having the Follower role 10 include:
a) Follow one or more Users FIG. 2:1-3 and view their statistics 24, Ranks 25 and Top competitors 26 awards.
b) Follow one or more Activities 10 and view Statistics 24 of its Events 23.
c) Follow one or more Events 23 by viewing Statistics 24 and other data as they're produced.
d) Vote on polls, surveys or contests to qualify any element of the network.

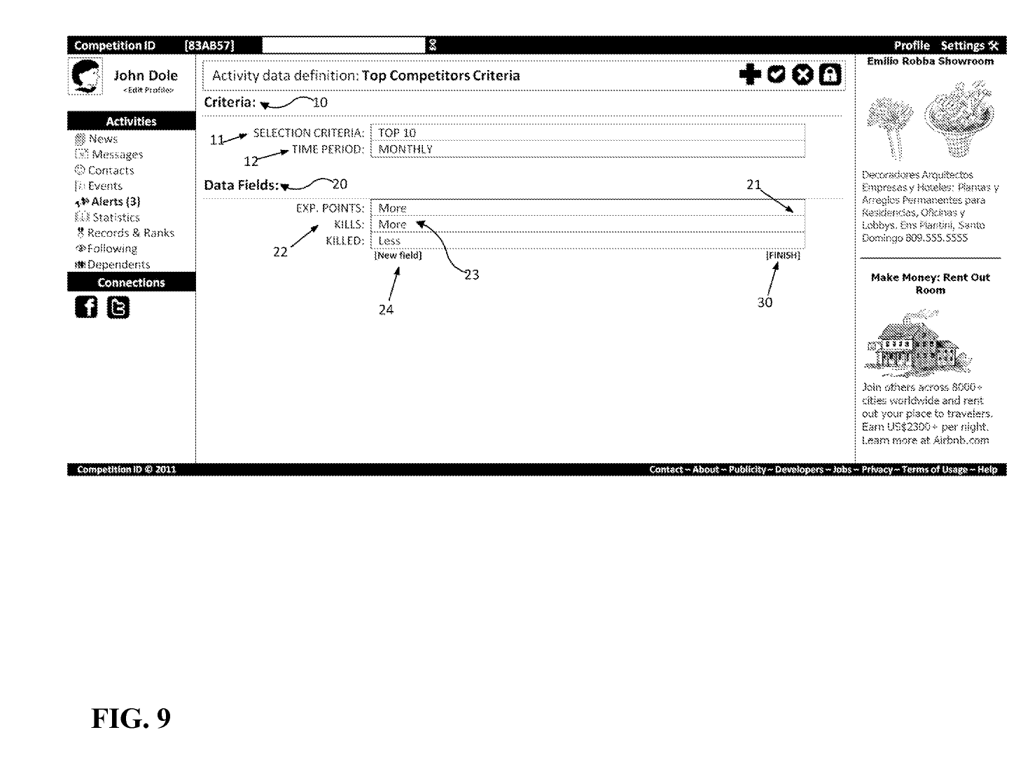

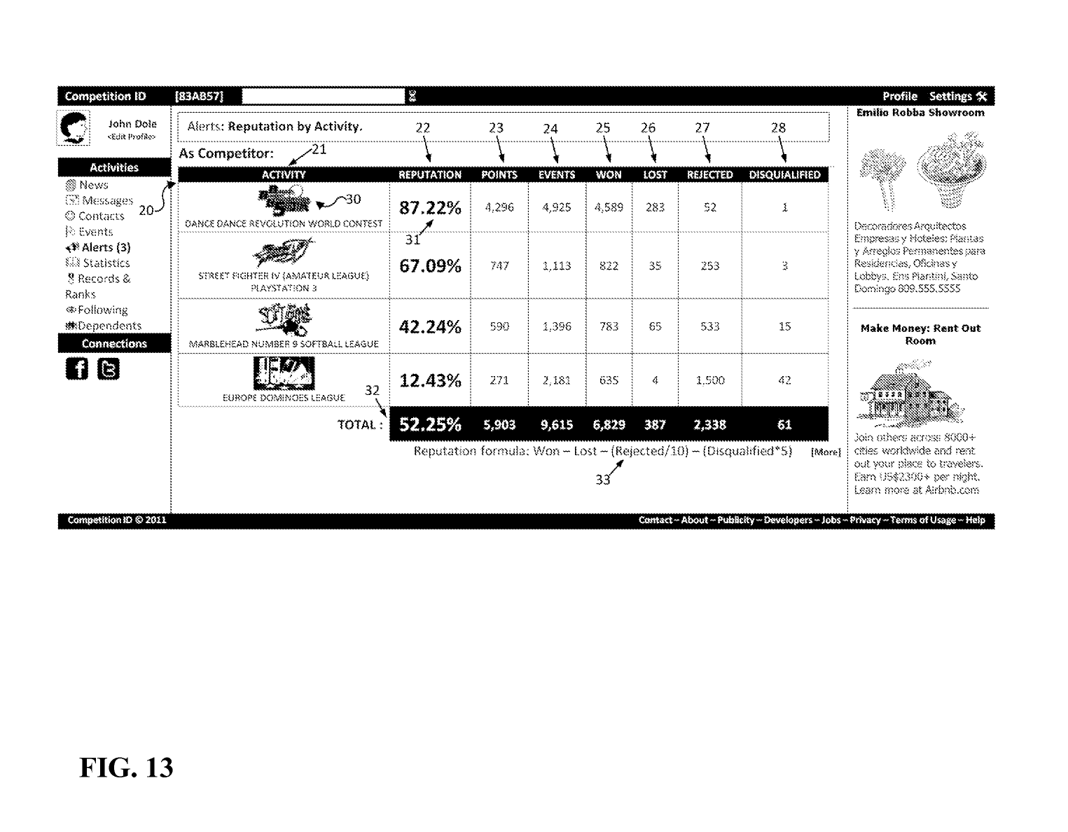

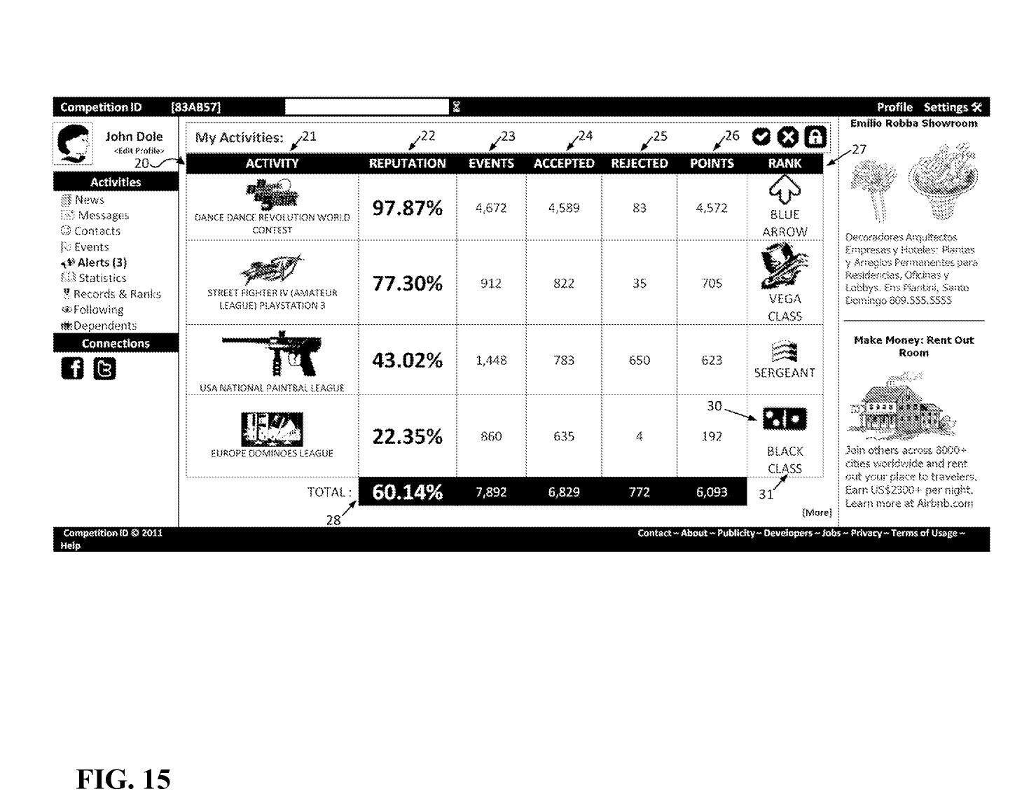

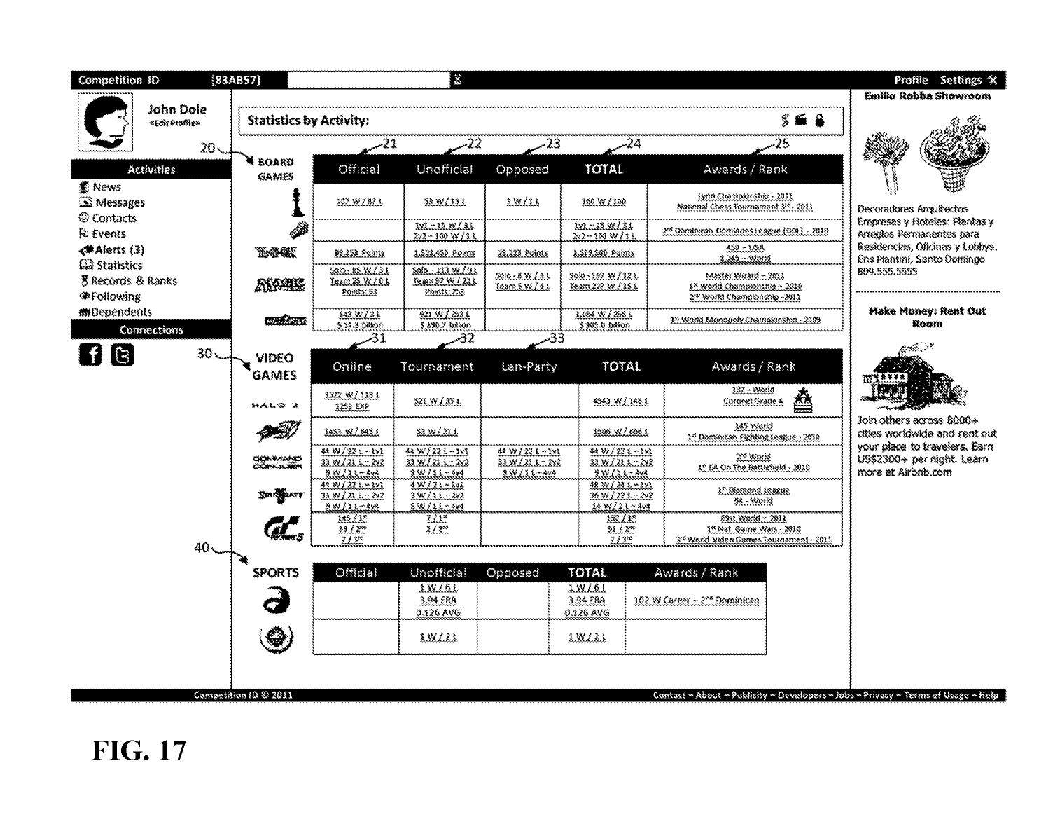

The Competitor role 11 is reserved for those users that compete in Events 23. Competitor users 11 can have access to Events 23 by accepting “Challenge request” FIG. 9 from Commissioner users or Sponsor users; or an special event can be created when a Competitor user accepts a Challenge Request from other Competitor user. Operations that user can perform having the Competitor 11 role include:
a) View statistics 24 and Top competitors 26 of an Activity he is invited to or belongs to.
b) Send or accept challenge request.
c) Propose or Reject an Arbiter 12 on an Event 23 he is invited to.
d) View statistics 24 or Activities 20 and Events 20 he participated in.
e) Share any Rank 25, Top Competitor 26 award or achievement he received.
f) Ask a Commissioner 13 or Arbiter user 12 to review, disqualify or cancel Events 23, other Arbiters users 12 or Competitors 11.
g) Send, accept or reject requests such as Team, Challenge or follow.
h) View ratings and reputation they have received by attending to Events FIG. 13, FIG. 15, FIG. 17. Competitors can receive votes from follower users such as Like/Dislike or 1 to 5 star rating. Reputation is calculated according to a formula that can be defined by a Commissioner user 13.

The Arbiter user role 12 is designed for users that interact with the Event database entity 23 to enforce rules and certify its data. There is a restriction that prevents users from having both the Competitor 11 and Arbiter 12 role in the same Event instance, only Robot users FIG. 2:3 can have both Competitor 11 and Arbiter 12 user roles in the same event instance 23.

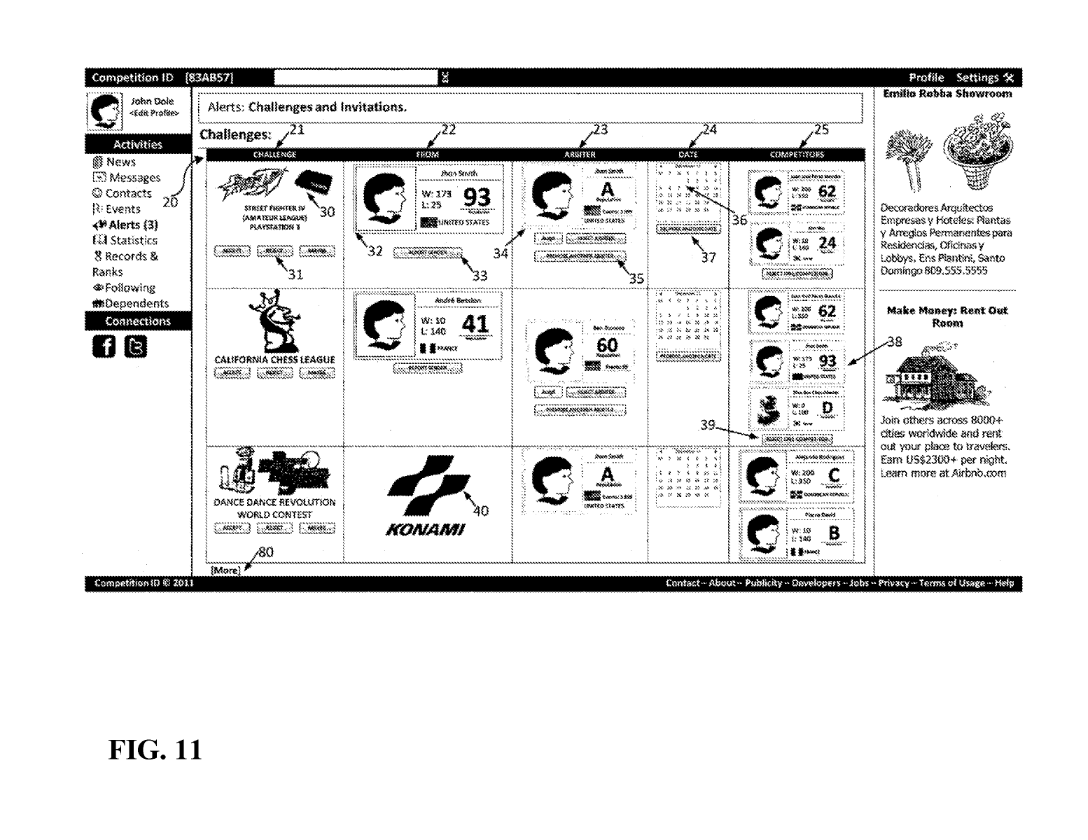

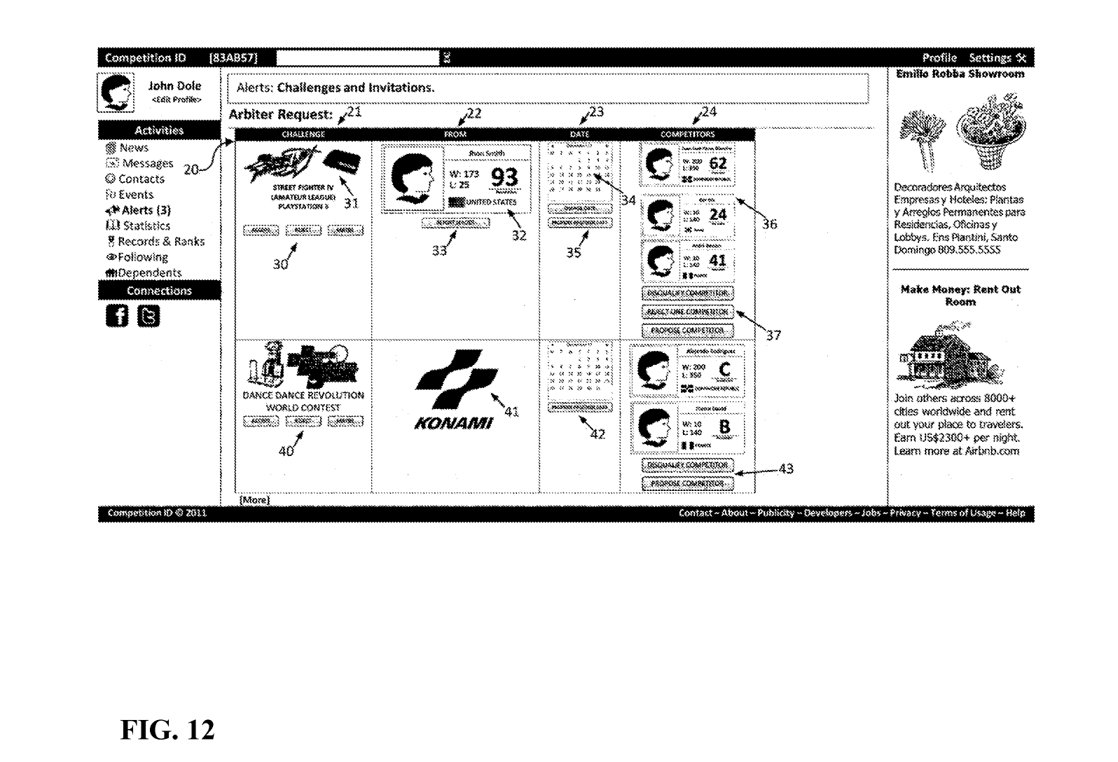

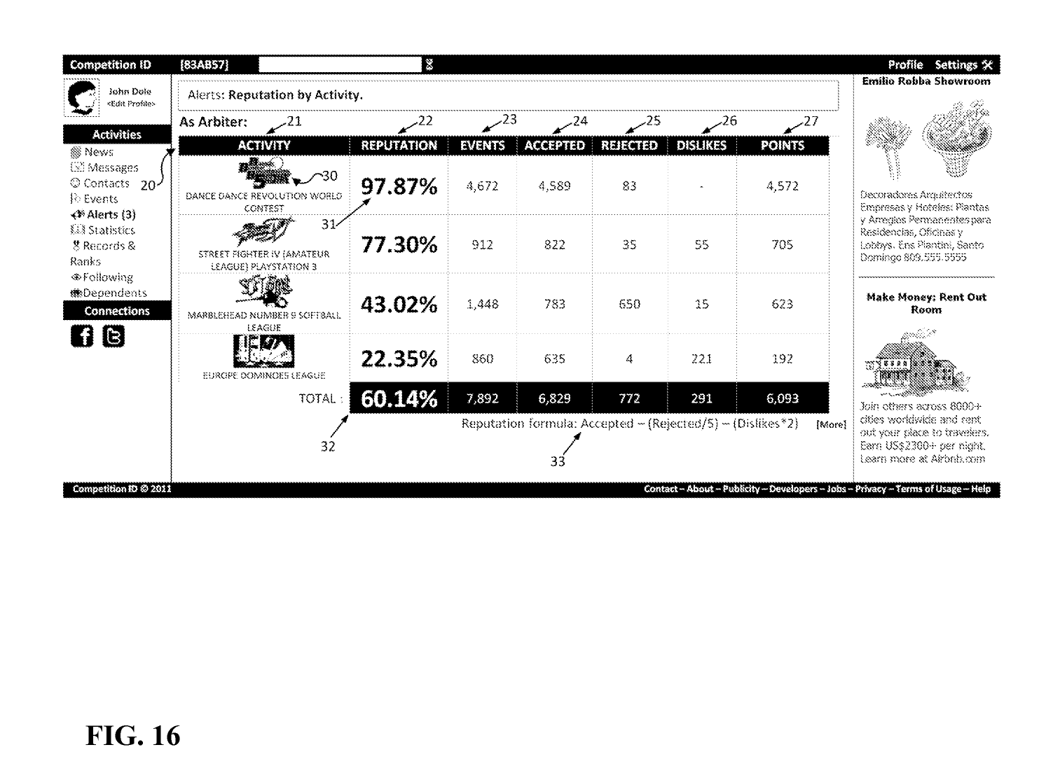

The Arbiter user role 12 can be temporarily assigned to a user if he is chosen by Competitor users 11 that want to compete between them; in that case an Arbiter request FIG. 11 is sent to the user. After accepting the Arbiter request FIG. 12 to judge an Event 23 users having the Arbiter user role 12 can perform operations such as:
a) Approve and certify the data captured in an Event 23 instance.
b) Disqualify Competitors 11 and specific data.
c) Reschedule, cancel or postpone an Event 23.
d) View general information of the Activity 20 that the Event 23 belongs.
e) Review Competition data 21, Formulas 22, and other rules that govern the event 23.
f) View Statistics 24 of all Competitors 11 attending to the Event 23.
g) View profiles of all Competitors 11 attending to the Event 23 and the Dependent members FIG. 2:20-26 they will use if any.
g) View the qualifications he received by attending to Events 23 and his reputation FIG. 16. Arbiters can receive votes such as: likes, dislikes or 1 to 5 star qualifications.

The Commissioner user role 13 is the highest role; a Commissioner user can govern all aspect of an Activity 20, and all instances of Competition data 21, Formula 22, Event 23, Statistics 24, Rank 25 and Top Competitors 26 database occurrences of the Activity that belongs to him. This role can be obtained when a User FIG. 2:1-3 creates an Activity 20, or when a Sponsor user 14, passes him full control of an Activity 20 he created. Operations that a user can perform having the Commissioner user role 13 include:
a) Create or change competition Activities 20 with all related databases occurrences in the database instances 21-26.
b) Accept “Commissioner requests” from one or more Sponsor users 14 to manage an Activity 20 they created.
c) Define or change Competition data 21, Formulas 22, Rank systems 25, and Top Competitors 26 criteria at any time.
d) Deactivate or disqualify Event 23 instances, forcing statistics for all users attending to those events to be recalculated.
e) Send invitations to other users to subscribe to the Activity 20 he is in charge of.
f) Approve subscriptions to the Activity 20 he is in charge.
g) When attending to an Event 23, a Commissioner 13 can have all functions of an Arbiter user 12 if he is not competing in the same event.
h) Disqualify one or more Arbiters users 12, and solve disputes by responding to “Dispute request” from users subscribed to his Activity 20.
i) Close his Activity 20. When this operation is performed all data and achievements remain and the Statistics 24 and Ranks 25 of the Competitors users 11 remain in their profiles FIG. 13.
j) Transfer his role to other user in case he decides not to support his Activity 20 anymore.

The Sponsor user role 14 is designed for those users FIG. 2:1-3 who want to create and promote competition activities related to their brand or name. Sponsors users 14 can create Activities 20 with all related database entities and instances 21-26 and transfer the administration to other users later on. Sponsor users 14 can retain some rights over the Activities 20 they created and perform some operations such as invite to Events 23 or Managing Formulas 22 to view statistics the way they want. Operations a user can do having the Sponsor user role 14 include:
a) Create a competition Activity 20 with all related database instances 21-26 to later transfer administrative functions to another user who then become the Commissioner 13 of the Activity 20.
b) View all database instances he created 21-26 related to the activity 20 he created.
c) Define and Apply his own Formulas 22 to view Statistics 24 from the Activity 20 he created the way he wants.

d) Schedule, reschedule, postpone or cancel Events 23 of the Activity 20 he created.

e) View Ranks 25 and Top Competitors 26 awards of the Activity 20 he created.

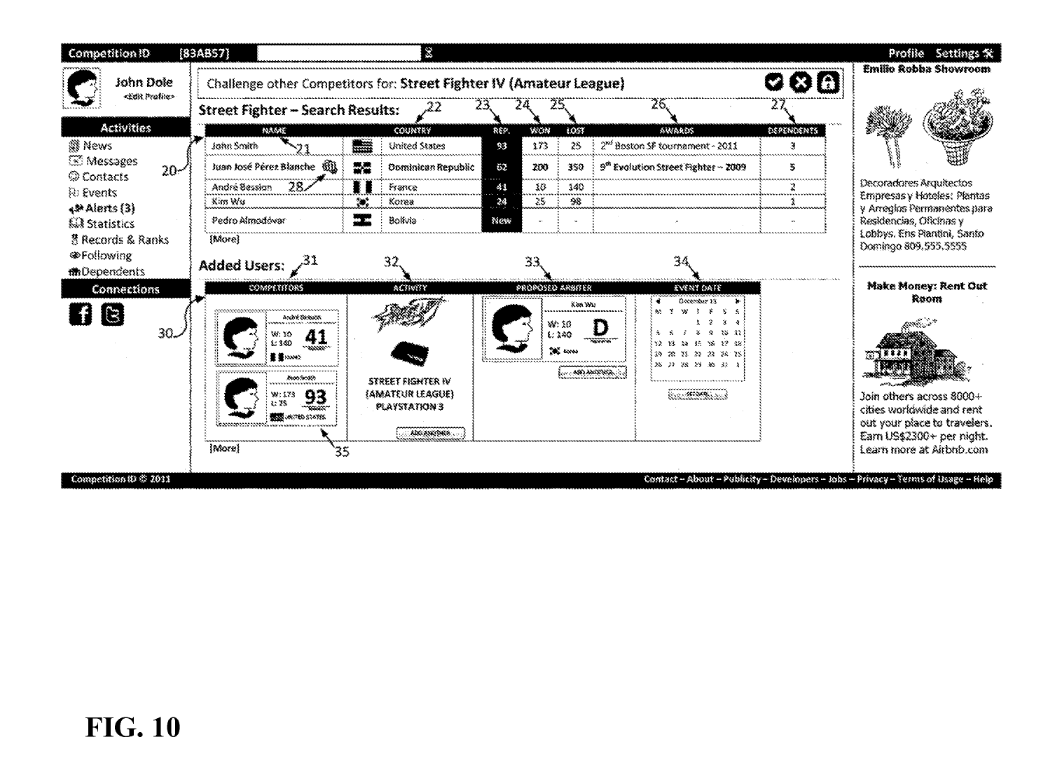

f) Send Challenge request FIG. 10 to other Users FIG. 2:1-3 asking them to participate on one or more Events 23 of the activity he created.

The Scout user role 15 is reserved for users who want to find talented Competitors 11, Dependent Members FIG. 2:20-26 or other elements of the networks with special conditions of their interest. Scout users 15 must be accepted by Commissioner users to see the data of any given Activity 20. After being accepted in an Activity 20 Scout users 15 can perform operations that include:
a) Define or apply his own Formulas 22 to see the Statistics 24 of an Activity 20 the way he wants.
b) View Ranks 25 and Top Competitors 26 awards of an Activity 20.

The Annotator user role 16 is designed for users that capture or enter data to Event instances 23. Data entered by Annotator users can be marked as “unofficial” until is certified by an Arbiter or Commissioner user. Operations that users can do having the Annotator user role 16 include:
a) Interact with the event 23 database instance to enter data. All data entered in the event instance is validated according to the Data definition FIG. 4:3, and Data rules FIG. 4:4 database entities that the Commissioner user defined when created the Activity 20.
b) View the statistics of the Event 10 he is annotating.

All database entities 20-26, User roles 10-16 and any other operation can be monitored by one or more Administrator users 4 to enforce policies and solve disputes.

FIG. 4 is a block diagram showing a detailed description of database entities, entity relations and the information flow needed to generate a user profile to show all activities related to a given user. The diagram shows several database entities 1-10 connected by one to may relationships. A database entity can be allocated on one or more physical or virtual database servers FIG. 1:33 and can comprise of one or more tables managed by relational or non-relational database engines.

Therefore database entities with few changes over time like User 1 or Activity 2 can be normalized and managed by relational database engines. On the other hand Data definition 3, Data Rules 4, Raw Data 5, Formulas 6, Statistics 7, Ranks 8 and Top Competitors 9 are more likely to be stored in narrative XML language because his semi structured schema. Those narrative database entities are more likely to me managed by one or more No-SQL database engines located in one or more Database servers FIG. 1:33.

In the User database entity 1 only basic user data is kept such as email if the user is older than 13, an Internal ID or assigned User roles FIG. 2:10-16. Other personal information can be entered when the user subscribe to an Activity FIG. 3:20 only if the information is marked as required to subscribe. Commissioner FIG. 3:13 or Sponsor FIG. 3:14 users can declare this information as required when defining the data types in the Competition Data database entity FIG. 3:21.

When a user decides to leave the network only the email data entry if the user is older than 13 is physically deleted from the User Database Entity 1 leaving ID, user roles and other linking data fields intact for consistency purposes. Also when this situation occurs all personal data that the user entered in all activities is substituted by the words “Deleted user” or “Deactivated profile”

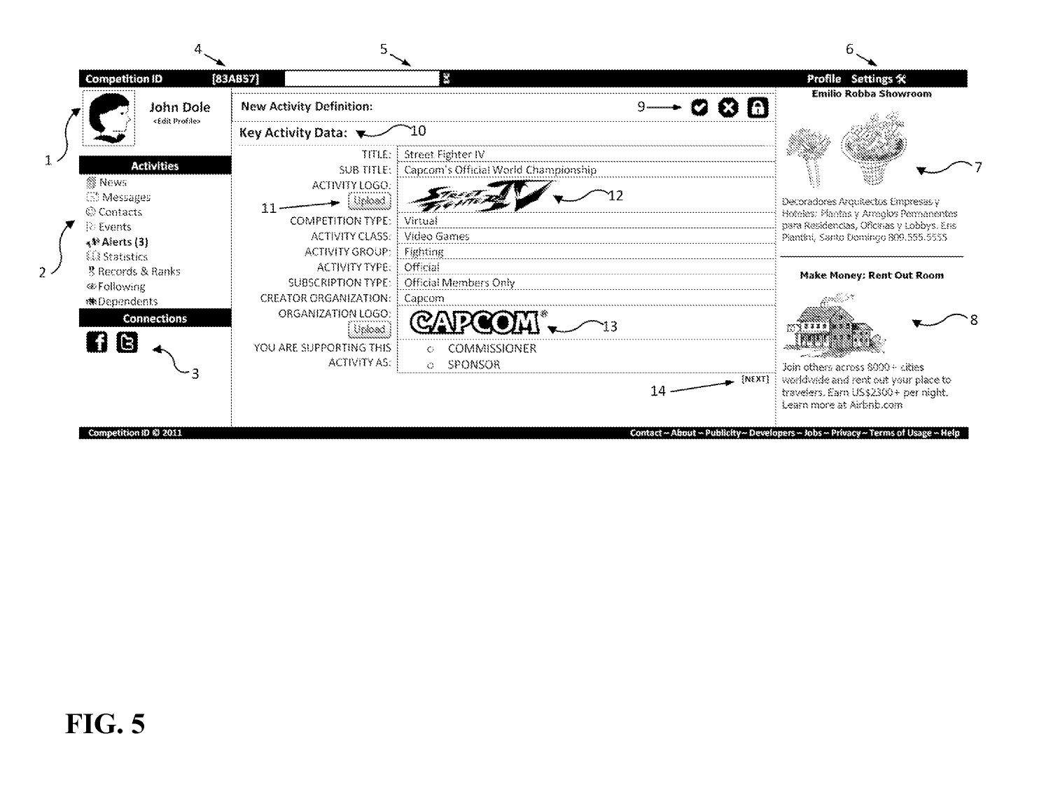

The Activity database entity 2 is the grand parent of all related data in the network and connects a user with all data generated on each entry or database instance 3-10. General information about the activity can be specified here such as: Title, Subtitle, Activity Logo, Company Logo or Activity class. Contents of this entity can be created or modified in the Activity Definition Screen FIG. 5 by Commissioner FIG. 3:13 or Sponsor FIG. 3:14 user.

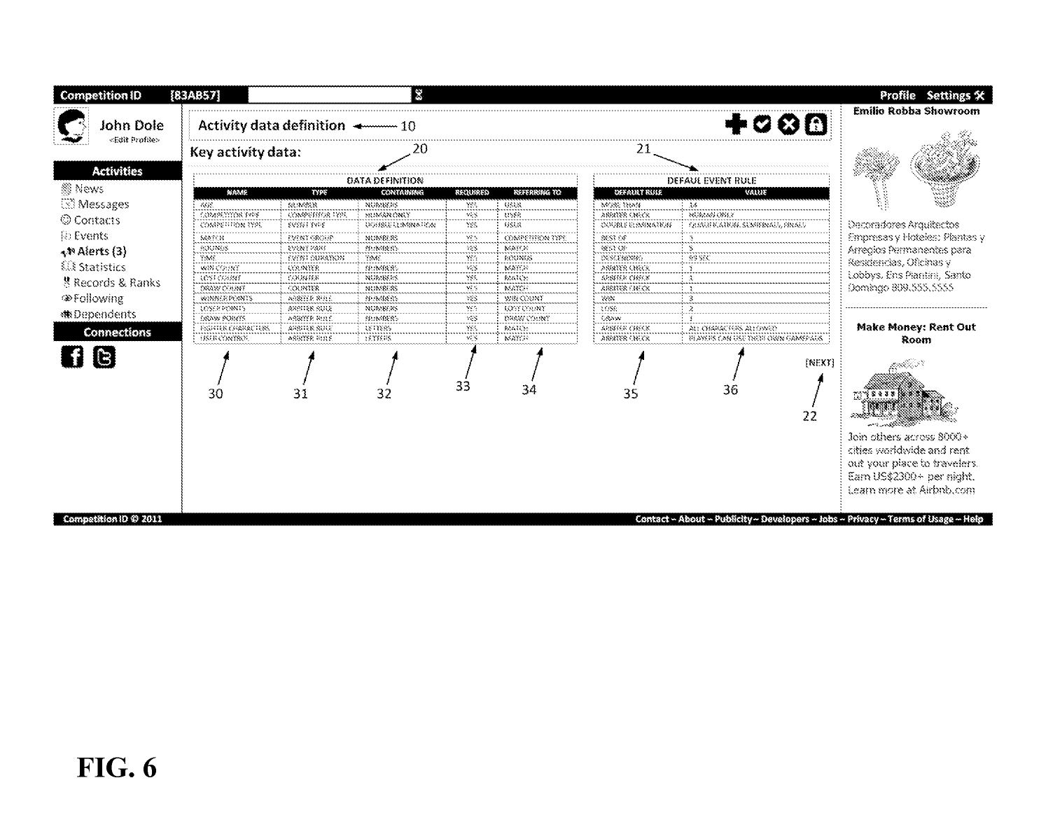

The data definition database entity 3 contains general specifications about the data that can be stored such as: Data name or Data Type. This entity also contains general rules about the type of information that can be stored such as Number, Letters, or if a data entry is required to have a value. Contents on this entity can be created or modified in the Activity data definition screen FIG. 6 by a Commissioner FIG. 3:13 or Sponsor FIG. 3:14 user.

The Data Rules database entity 4 contains one or more set of rules that must be validated when entering data in an Event FIG. 3:23. This set of rules may vary from one event to another and can be applied to one or more data entries of the Raw Data database entity 5 to validate en ensure rules that the Commissioner FIG. 3:13 or Sponsor FIG. 3:14 have set. Contents on this entity can be created or modified in the Activity data definition screen FIG. 6 by a Commissioner FIG. 3:13 or Sponsor FIG. 3:14 user.

The Raw Data database entity 5 is the primary source for all data calculations by containing special fields to link the data with Event Occurrences FIG. 3:23 ensuring data consistency. Each time a data is entered in an Event FIG. 3:23 an entry in the Raw Data database entity 5 is created, and then is validated using the rules defined on the Data Definition 3 and Data Rules 4 database entities. Contents of this database entity are created or updated when an Annotator user FIG. 3:16 enters the data in the name of the Competitor FIG. 3:11 that is attending to an Event FIG. 3:23.

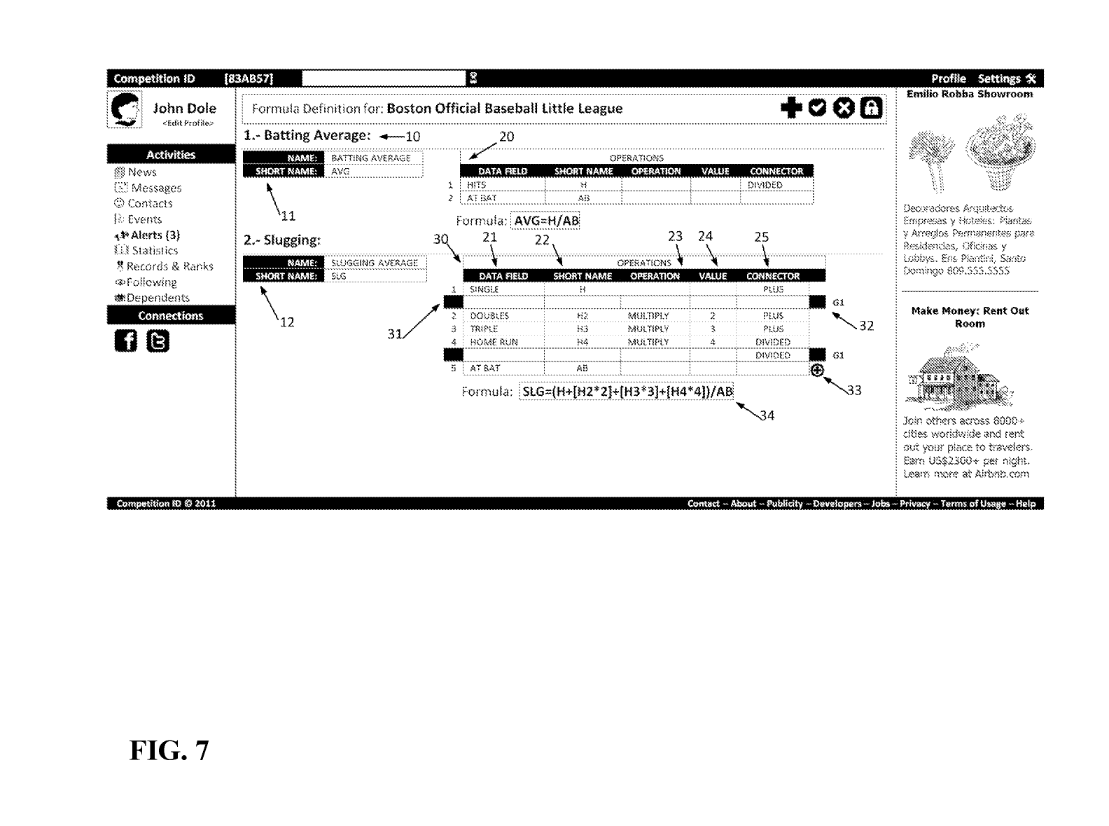

The formula database entity 6 contains the necessary calculation steps and connection specifications between data elements to produce one or more Statistics 7. Contents on this entity can be created or modified in the Formula definition screen FIG. 7 by a Commissioner FIG. 3:13 or Sponsor FIG. 3:14 user.

The Statistics database entity 7 contains the results of one or more Formulas 6 grouped by Activity 2. Contents of this database entity are generated automatically in time periods regulated by Administrator users FIG. 3:4 to ensure the high availability of completion results.

The Ranks database entity 8 contains a set of awards that can be applied to the users and the rules they must meet to receive those distinctions. Awards definitions in this entity can contain letters, numbers, graphics or any combination of the three. Contents on this entity can be created or modified in the Rank definition screen FIG. 8 by a Commissioner FIG. 3:13 or Sponsor FIG. 3:14 user.

The top Competitors database entity 9 contains rules for calculating and selecting the best competitors of an Activity 2. Data for this calculation and selection criteria are taken from the Statistics database entity 7. A time frame can be set by a Commissioner FIG. 3:13 or Sponsor user FIG. 3:14 to calculate the best competitors of the activity, in that manner the best Competitors of an Activity FIG. 3:20 can be shown by period of time such as: hourly, daily, weekly monthly or yearly.

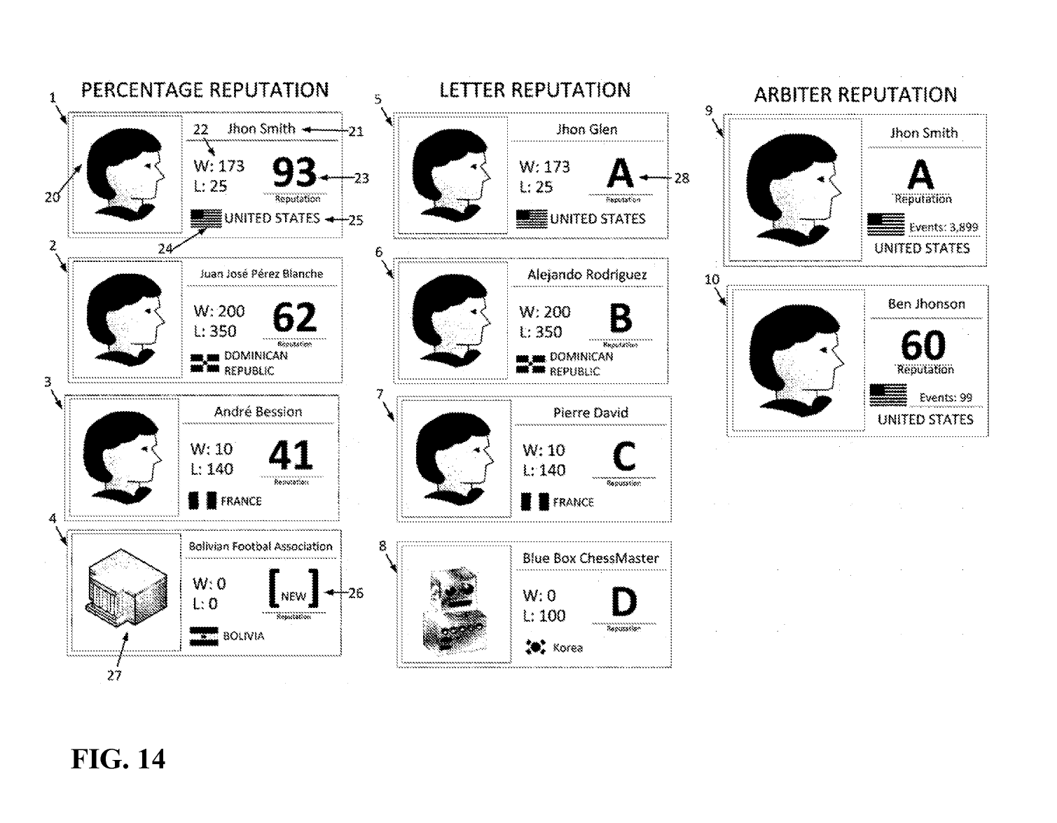

The Activity Profile database entity 10 contains on demand results from the Statistics, 7, Ranks 8 and Top Competitors 9 database entities. Results stored in this database entity may vary each time a user logs into the network and his profile is shown or when internal database calculations are made and his profile is refreshed. A User FIG. 2:1-3 can have multiple Statistics 7, Ranks 8 or Top competitor 9 results from one or more activities 2. In this manner the Activity profile database entity 10 provides a centralized way for Users FIG. 2:1-3 to see all results for one or more activities 2. FIG. 14, FIG. 15, FIG. 16.

Other database entities are used for internal operations such as: Activity linking, user security, account restoration, chat sessions, sending and accepting request, COPPA rules or cache operations. Those database entities were not shown because they're not needed to comprehend the invention.

Exemplary dynamically generated user profiles are shown from FIG. 5 to FIG. 27, with the exception of FIG. 13. Those user profiles have common areas, icons and operation indicators the user can activate, those common elements include:

The User identification section 1 that can be conform of a picture, a nickname and a link that takes the user to modify his main profile data.

The Activities section 2 that can be conformed of icons and text hyperlinks that the user can use to go to other sections of his profile or to perform operations according to his user role FIG. 3:10-16.

The Connection section 3 shows the subscription the user has to share his statistics or achievements on other networks.

The Outer frame 4 at the top line can be conformed of the site logo, a generated internal ID of the user at the top and the copyright information along with other text or graphics links managed by the company that runs the network at the bottom.

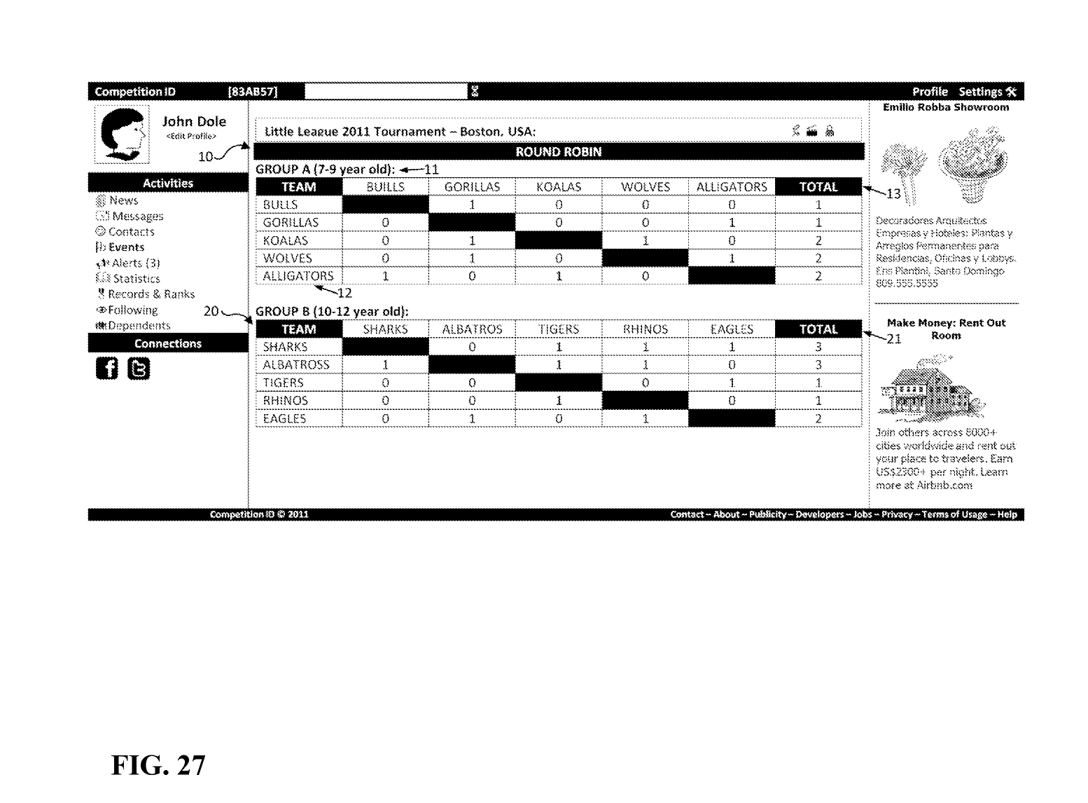

The Search bar section 5 can take the user to the search section FIG. 27 to find topics of his interest or to Challenge other users FIG. 10.

Profile Settings section 6 takes the user to an administrative section where he can change his privacy settings, manage subscriptions or deactivate his account.

Advertisement sections 7 and 8 are shown based on operations the user is doing or where he is going on the network. Those advertisements are managed by the company that runs the network and are based on user age; no advertisement is shown below the age limit stated by COPPA (13 or younger by 2013).

Operation icons 9 are graphics representations of status or operations a user can do in his profile. Those operations icons can change when he is visiting another profile such as: another user FIG. 2:1-3, or Dependent Member FIG. 2:20-26.

When representing one or more status those icon can be:
a) Chain: representing a link to other section of the network.
b) Film slate: representing a video link.
c) Padlock: indicating that the data shown is locked and cannot be changed.

When representing one or more operations those icons can be:
a) Plus sign: indicating that when pressed a new element will be added.
b) Check mark: indicating that when pressed data will be saved.
c) X sign: indicating that when pressed all new edits will be discarded.
d) Padlock: indicating that when pressed all new edits will be disallowed.

Other examples of dynamically generated user profiles screens such as: Activity subscription, Dispute request, Contact management, Profile preferences or Login section where not included because they're not needed to comprehend the invention.

FIG. 5 shows the first step of the activity definition process: The main activity definition by a Commissioner FIG. 2:13 or Sponsor FIG. 2:14 user. The Key activity data definition table 10 contains the fields and definitions that will identify the activity in the network. This information is stored in the Activity database entity FIG. 4:2.

One or more activity definition fields can be defined in the Key Activity data table 10 such as:
a) Title: is the primary text line which is shown as the main identification of the activity in the network.
b) Subtitle: a second line which shows more information about the activity.
c) Activity logo 12: is a graphical representation of the activity that the user can upload by pressing the Upload button 11. The uploaded picture or graphic is shown along with the title of the activity in the network.
d) Competition type: defines the environment where the activity takes place: the user can choose from “live” if it takes place on a physical environment or “virtual” if the activity takes place in cyberspace or a computer generated environment.
e) Activity class: is an internal classification of the activities made by the company that runs the network, the user can create a new Activity class if he wants.
f) Activity group: is an internal sub classification of the activities made by the company that runs the network, the user can create a new Activity group if he wants.
g) Activity type: Defines if the activity is managed by an organization and if their results will be marked as “official” in Competitors user profiles FIG. 15.
h) Subscription type: governs which type of competitors can join an activity, in this case only members of the organization can join the activity.
i) Organization logo 13: is the graphical representation of the organization to which the activity belongs.

The “NEXT” text hyperlink 14 when pressed takes the user to the next step of the activity definition process: the Activity data definition FIG. 6.

FIG. 6 shows the second step of the activity definition process: two tables on the screen are used for Activity data definition: the Data definition table 20 and de Default event rule table 21. Entries in the Data definition table 20 are stored in the Data definition database entity FIG. 4:3 while the contents of the Default event rule table are stored in the Data Rules database entity FIG. 4:4. Predefined attributes in conjunction with other fields that the user must fill can be used to create a data definition.

Definitions in the Data definitions table 20 can be made by filling the filling columns in the Data definition table 20 such as:
a) Name 30: A custom name for each data definition can be defining by the user by typing any name.
b) Type 31: predefined data types can be used to define de behavior of each data definition such as:
   1) Number: Only numbers are allowed.
   2) Competitor type: defines what kind of competitor or users can compete in the activity FIG. 2.
   3) Event group: Defines a container for one or more events.
   4) Event part: Defines a member event for an event container.
   5) Event duration: defines a time period in which the event should take place and a top limit in which the event should end.
   6) Counter: defines a numeric container to store the result of a sequence of addition or subtraction of numeric values.
   7) Arbiter rule: Indicates a value, data or operation that one or more Arbiter users FIG. 3:12 must enforce when judging an Event FIG. 3:23.
c) Containing 32: are predefined containers that can be set to control the kind of information a data definition can store such as:
   1) Numbers: Only numbers are allowed.
   2) Human Only: Only Human users FIG. 2:1 are allowed.
   3) Double elimination: Indicate that attending Competitors FIG. 3:11 to an Event FIG. 3:23 must lose twice to be defeated.
   4) Time: a numeric value representing time intervals.
   5) Letters: only alphanumeric characters are allowed.
d) Required 33: indicates if a data definition is required or can be omitted.
e) Referring to 34: indicates if the current definition is applied as a rule to a previously defined element. The name of the Data definition element 30 can be specified on each row. Also predefined rules can be applied such as:
   1) User: rule is applied to the user FIG. 2:1-3.
   2) Event: rule is applied to the event FIG. 3:23.
f) Default rules and values can be defined on each data definition entry in the Data definition table 20 by adding values to corresponding lines in the Default event Rule table 21. Values on both Default rule 35 and Value 36 columns can be combined to enforce rules such as:
   1) More than: A value or quantity must be higher than a given amount or quantity.
   2) Arbiter check: indicates that the Arbiter FIG. 2:12 must manually check or verify a rule.
   3) Best of: evaluates several win/lost counts of a series of events to determine the winner, the amount of events are usually odd numbers.
   4) Descending: indicates a descending order for a time data type.
   5) Ascending: indicates a ascending order for a time data type.
   6) Win: defines which reward, point or punishment the competitor will receive for winning
   7) Lose: defines which reward, point or punishment the competitor will receive for losing.
   8) Draw: defines which reward, point of punishment the competitor will receive for ending tied in an Event FIG. 2:23.

Therefore by analyzing the Data definition 20 and the Default event rule 21 tables we can conclude that all Event instances FIG. 3:23 of this exemplary videogame activity will have the following behavior:
a) Configuration: A double elimination tournament, judging the best of 3 matches of five rounds of 99 seconds. The event is divided into three parts: Qualification, Semifinals and Finals.
b) Restrictions: only humans 14 or older are accepted.
c) Points and rewards: win, lose and draw counts valued as 1 and are enforced by Arbiters FIG. 3:12. Competitors can gain points for participating such as: 3 when winning, 2 when losing and 1 when tying.
d) Rules: All characters are allowed and Competitors FIG. 3:11 which are called “Players” in the event can use their own gamepads.

FIG. 7 shows the third step of the definition process: The Formula definition. Here the user can define formulas that will be used to calculate statistics FIG. 3:24. Definitions on this screen are stored in the Formula Database entity FIG. 4:6.

One or more formulas can be defined by adding a Primary definition comprising of a Title 10 plus a Short name 11, 12. Then calculations steps and parts can be added on the corresponding operations table 20, 30 with specifications columns such as:
a) Data field 21: containing the data field that will be the source of the calculation. The fields that the user can choose in this column correspond to one of the fields he defined in the Key activity data screen FIG. 6 and are taken from the Data definition database entity FIG. 4:3.
b) Short name 22: containing an abbreviation for the name.
c) Operation 23: containing a name for the mathematical or logical operation that will be performed using the data stored in the Data field 21 such as: Add, Subtract, Multiply, Divide or Power.
d) Value 24: containing a value specified by the user.
e) Connector 25: containing the name of a mathematical operation that will also serve as a connector to another line or group of operations 31, 32.

At the bottom of each operation table 20, 30 a result formula field 34 is shown. Users can also specify the formula by typing onto this field; the Operations table 20, 30 are then filled with lines or groups after this field is validated.

Users can either add a line or a group by pressing the Plus icon 33, then group indicators 31, 32 marks the beginning and end of each group.

All fields that can be chosen on Operation tables 20, 30 correspond to Data types and definitions of the Data Definition database entity FIG. 4:3 to make sure the user is applying formulas to previously defined data. Some validations rules can be applied to make sure the user is not applying wrong operations to previously defined data like multiplying an alphanumeric value.

FIG. 8 shows the fourth step of the Activity definition process: the Ranks definition. The rules to define ranks are stored in the Ranks database entity FIG. 4:8. All database fields and specifications are taken from the data Definition database entity FIG. 4:3 to avoid users referring to invalid data.

Ranks definitions are made by adding Lines 20 or Groups 21 to the Ranks definition table 10 containing definition columns such as:
a) Logo 11: a graphical representation of the rank
b) Name 12: a name that the user can specify by typing directly to the cell.
c) Short name 13: an abbreviation of the name that the user can specify by typing directly to the cell.
d) Data 14: A field from the Data definition database entity FIG. 4:3 that is used to calculate the rank or award.
e) Condition 15: a rule or calculation used to determine the rank or award, such as:
   1) Default: applied if no other value exists.
   2) More than: applied when the data passes a specified numeric value.
   3) Between: applied when the data is in between two numeric values specified in Value 1 16 and Value 2 17 columns.
   f) Value 1 16: containing the first value used to evaluate the condition 15
   g) Value 2 17: containing the second value used to evaluate the condition 15.
   h) Prerequisite 18: indicating if a rank from a previous line is also required.

Group definitions 21 can be added to apply a rank or award which requires more than one line of specification. Users can add a group by pressing the Add group link 26. Group definitions are marked by highlighted lines 23 and can contain lines of definitions or links to previous definitions 24 to apply all of them as a whole.

Therefore by analyzing FIG. 8 we can conclude that the following ranks will applied to the competitors called “Players” in an exemplary Paint ball activity:
a) Recruit: when the player joins the activity and has no data.
b) Private: When the player has more than 5 kills.
c) Skill level 1: when the player experience is more than 100 points.
d) Skill level 2: when the player experience is more than 1,000 points.
e) Skill level 3: when the player experience is more than 10,000 points.
f) Commander: when the player experience is between 100 and 500 points having the Private Rank.
g) Sergeant: when the player has Private, Commander and Skill level 1 applied.
h) Captain: when the player has both Sergeant and Skill level 2 ranks applied.
i) Colonel: when the player have both Captain and Skill level 3 applied.

When participating on this exemplary activity, a player having 12 kills and 754 experience points is awarded with the following awards: Private, Skill Level 1, Commander and Sergeant.

FIG. 9 shows the last step in the activity creation process: the Top Competitors criteria definition. Top Competitors criteria definitions are stored in the Top Competitors database entity FIG. 4:9. Commissioner FIG. 2:13 or Sponsor FIG. 2:14 users can specify Top competitor rules by specifying the Criteria 10 and the relevant Data fields 20 to be taken into account in the selection process.

The selection criteria 11 can have pre-defined selection rules such as:
a) Top 100: only the best 100 competitors are awarded.
b) Top 10: only the best 10 competitors are awarded.
c) Top 5: only the best 5 competitors are awarded.
d) Top 3: only the best 3 competitors are awarded.
e) Ladder: When a competitor loses in an event, he changes position with the competitor who defeated him; if he wins he goes up one position.
f) Sequential ladder: When a competitor loses in an event, he goes down one position, if he wins goes up one position.

When defining data fields 20 that are used to choose the best competitors of an Activity FIG. 3:20, the user can add them user the New field link 24. All fields that can be specified 22 in the Specification fields table 21 correspond to those defined in the Data definition database entity FIG. 4:3 to ensure the user is referring to existing data. After a Field 22 is specified in the Data fields table 20 a rule 23 can be defined for that field such as:
a) More: The competitor with the higher quantity is taken into account.
b) Less: The competitor with the lower quantity is taken into account.
c) Title: The competitor with a predefined alphanumeric value is taken into account.

Therefore by analyzing FIG. 9 we can conclude that for an exemplary Paint ball activity the top competitors called “Players” will the 10 with most experience point and kills, but with less times being killed by other players.

When the user presses the FINISH link 30 the process of creating an activity is concluded and the activity is ready. At this point a Sponsor user FIG. 3:14 can pass the administration of the activity to a Commissioner user FIG. 3:13.

In an internet competition network interpersonal relationships are established by the interaction of the users in relation to the activities they do or the organizations they belong. That way real live relationships are recreated such as:
a) Teammate: designed for all members of the same team. Once a competitor joins a team, he and all other members are related with this relationship. Once the competitor leaves the team or is expelled this relationship is lost.
b) Mentor: designed for staff members that lead competitors, teams or organizations. Once a competitor joins a team or organization all mentors of the team or organization becomes his mentors. The relation is lost when a competitor leaves the team or organization or is expelled. The mentorship relation can also be automatically assigned when a user ask for assistance to another user sending a “Mentorship request” and is lost when the asking user declares his problem solved.
c) Colleague: Designed for mentors or staff members that support the same team or belong to the same organization. Once the user is accepted as mentor or staff all other mentors or staff members become his colleagues. The relationship is lost when the user leaves the organization or is expelled.
d) Opponent: A temporary relationship designed for competitors FIG. 3:11 that compete against each other for the duration of an event. FIG. 3:23. This relationship is lost when the event ends.
e) Rival: Designed for Competitors that compete against each other on a regular basis.
f) Enemy: Designed for competitors who compete in one or more events to eliminate each other. This relationship is reserved for Robot users FIG. 2:3 or competitors belonging to Virtual world or computer generated environments.

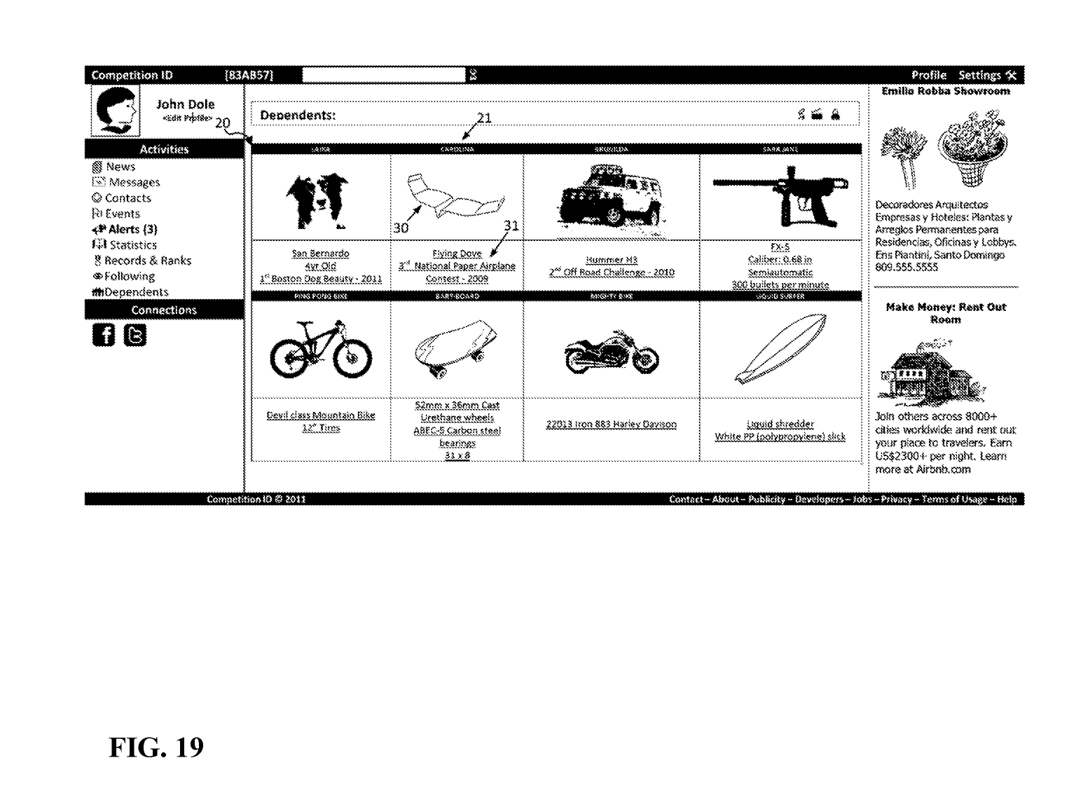

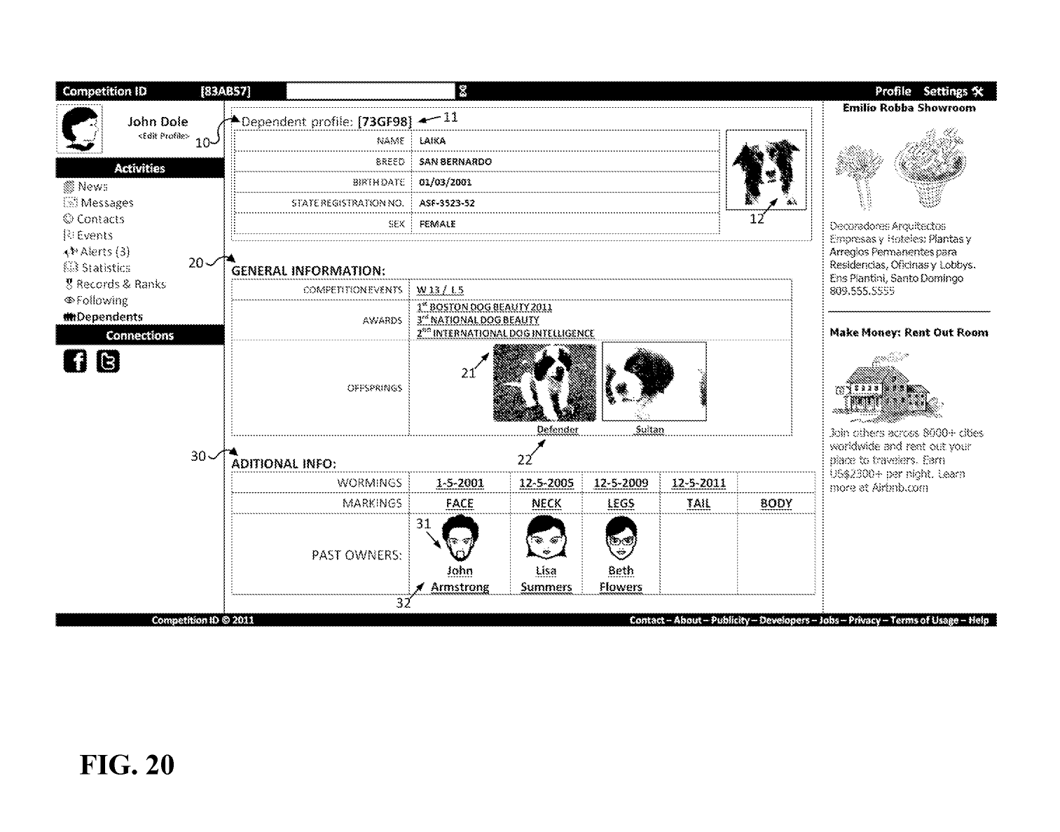

FIG. 10 shows the process of sending challenges requests to competitors of an exemplary video game activity. Users to invite can be found using the Search bar 5; by choosing one or more users to challenge the Invite table 20 is populated. The invite table 20 can contain challenge specification columns such as:
a) Name 21: name of the user.
b) Country 22: name of the country the user is from, also the country flag.
c) Rep. 23: reputation of the competitor FIG. 14.
d) Won 24: number of events won.
e) Lost 25: number of events lost.
f) Awards 26: awards and ranks received.
g) Dependents 27: a link with the number of dependent member profiles FIG. 19, FIG. 20.

Users can be added to the Added users table 30 using the Challenge icon 28, this table can contain the following columns:
a) Competitors 31: contains one or more Mini profiles FIG. 14 of the users that will be invited to the event.
b) Activity 32: Contains a general description of the activity that will be seen by the invited users, this description is taken from in the Main activity data definition FIG. 5. The user can add another activity to make a multi activity event by pressing the Add another button.
c) Proposed Arbiter 33: contains one or more Mini profiles FIG. 14 of the users that will serve as Arbiters having the Arbiter user role FIG. 3:12 during the event. The user can add another arbiter by pressing the Add another button.
d) Event date 34: contains one or more calendar control specifying the date or dates of the event. The user can click on one or more numbers representing days to set the date or dates of the event and then press the Set date button to save the changes.

Once finished selecting the Competitors FIG. 3:11 and the Arbiters FIG. 3:12 the user can press the check mark button on the Activity buttons bar 9 to set the event and send all Challenge FIG. 11 and Arbiter request FIG. 12 to the respective users.

FIG. 11 shows exemplary pending challenge invitations in a Competitor user profile. Pending challenges are displayed in the Challenges table 20 that containing specification columns such as:
a) Challenge 21: a brief description 30 of the activity that can be comprised of a title, a subtitle, and one or more logos as defined in the Main activity definition FIG. 5. The user can accept, reject or set it to respond later by pressing the Accept, Reject or Maybe buttons 31.
b) From 22: contains the mini profile 32, FIG. 14 of the user who sends the challenge request or invitation. The user can report the activity or event as a fraud by pressing the Report sender button 33. In case that the invitation is sent by an official organization or company 40 the user may not be able to report the event as a fraud or scam.
c) Arbiter 23: contains one or more Mini profile 34, FIG. 14 of one or more arbiters attending to the event. The user can accept, reject or suggest another arbiter by pressing either Accept, Reject or Propose another arbiter button 35. When the challenge is sent by an official organization the user may not be able to reject or propose another arbiter.
d) Date 24: contains a read only calendar control 36 showing the day or days of the event. The user can suggest or propose another date for the event by pressing the Propose another date button 37. When the challenge is sent by an official organization the user may not be able to suggest another date for the event.
e) Competitors 25: contains one or more Mini profiles FIG. 14 of all competitors attending to the event. The user can report a fraudulent competitor by pressing the Reject one competitor button 39.

The user can see more of his pending challenges by pressing the More link 80.

FIG. 12 shows exemplary pending arbiter request on a user profile. The events are shown in the Arbiter request table 20 which contains definition columns such as:
a) Challenge 21: containing general information of the activity 31 that can comprise of a Title and one or more logos or pictures as defined in the Main activity profile FIG. 5. The user can accept, reject or set it to respond later by pressing either Accept, Reject or Maybe buttons 30.
b) From 22: containing the Mini profile 32, FIG. 14 of the user who sent the request. The user can report the user and the activity as a fraud by pressing the Report sender button 33. This column can also contain an image or logo 41 representing an official organization or company. In case that the request is sent by an official organization or company the user may not be able to report the activity as a fraud.
c) Date 23: containing a calendar control 34 showing the day or days of the event. After accepting the request the user can propose other date or unilaterally change the date by clicking any numeric values in the calendar and pressing either Propose another date or Change date buttons 35.
d) Competitors 24: containing Mini profiles 36, FIG. 14 of all competitors attending to the event. After accepting the invitation to the event the user can disqualify, reject or propose competitors by pressing either Disqualify, competitor, Reject one competitor or Propose competitor buttons 37. In case that the request is sent by an official organization or company the user may not be able to reject competitors but the ability to disqualify or propose others competitors is retained by clicking either Disqualify competitor or Propose competitor buttons 43.

FIG. 13 shows an exemplary list of activities and reputation as competitor on a user profile. The reputation table 20 can contain specification columns such as:
a) Activity 21: containing the Title and the logo of the activity 30 as defined by its creator FIG. 5.
b) Reputation 22: containing a Percentage 31 or an alphabetic letter showing the qualification of the competitor on each activity.
c) Points 23: containing points quantities earned by winning or losing events.
d) Events 24: containing a counter showing the number of events that the user was invited to.
e) Won 25: containing a counter of won events.
f) Lost 26: containing a counter of lost events.
g) Rejected 27: containing a counter of rejected events.
h) Disqualified 28: containing a counter of event in which the user was disqualified.

A Summary line 32 containing a average of the reputation of all events and a total of each Points 23, Events 24, Won 25, Lost 26, Rejected 27 and Disqualified 28 columns is shown at the bottom. Also the Formula 33 used for the calculation is also shown below the Summary line 33.

FIG. 14 shows various exemplary Mini profiles which are a quick way to identify the user and his general data. Information on Mini profiles is always up to date and reflects how well or bad a competitor is performing on the network. Mini profiles can be conformed of an outer frame that can be filled with color according with the reputation qualification; in that sense a Mini profile can have its background color as follows:
a) Green 1, 5: if the user reputation is A or above 80%.
b) Orange 2, 6: if the user reputation is B or between 60% and 79%.
c) Yellow 3, 7: if the user reputation is C or between 40% and 59%
d) Red 8: if the reputation is D or below 40%
e) White 4: if the user is new and has not participated in any event.

Mini profiles can have other indicators such as: a User picture 20, 27, the Username or Nickname 21, Win/Lost counter 22, Reputation qualification 23, 28, Country flag 24 and Country Name 25. Information on Mini profiles is updated each time an Event FIG. 3:23 is closed and Statistics FIG. 3:24, FIG. 4:7 are recalculated.

FIG. 15 shows and exemplary listing of activities along with rank awards and reputation. Activities are shown in the Activities table 20 having specification columns such as:
a) Activity 21: containing the title and logo of the Activity FIG. 5.
b) Reputation 22: containing the reputation calculation.
c) Events 23: containing a counter of event requests received.
d) Accepted 24: containing a counter of the events attended.
e) Rejected 25: containing a counter of the events rejected.
f) Points 26: containing a total of points gained for winning or losing events.
g) Rank 27: containing the title and logo of the Rank applied FIG. 8.

A summary line 28 is shown at the bottom containing and average of all reputations and a total for the other columns.

FIG. 16 shows an exemplary Arbiter reputation listing on a user profile. Activities are shown in the Activities table 20 with specification columns such as:
a) Activity 21: containing the title and logo of the Activity FIG. 5.
b) Reputation 22: containing the reputation calculation.
c) Events 23: containing a counter of event requests received.
d) Accepted 24: containing a counter of the events attended.
e) Rejected 25: containing a counter of the events rejected.
f) Dislikes 26: containing a counter of dislikes votes received.
g) Points 27: containing a total of points gained for attending to events.

A summary line 32 is shown at the bottom with an average of the reputation of all activities and a total for the other columns. The Reputation formula 33 used for calculation is also shown below the Summary line 32.

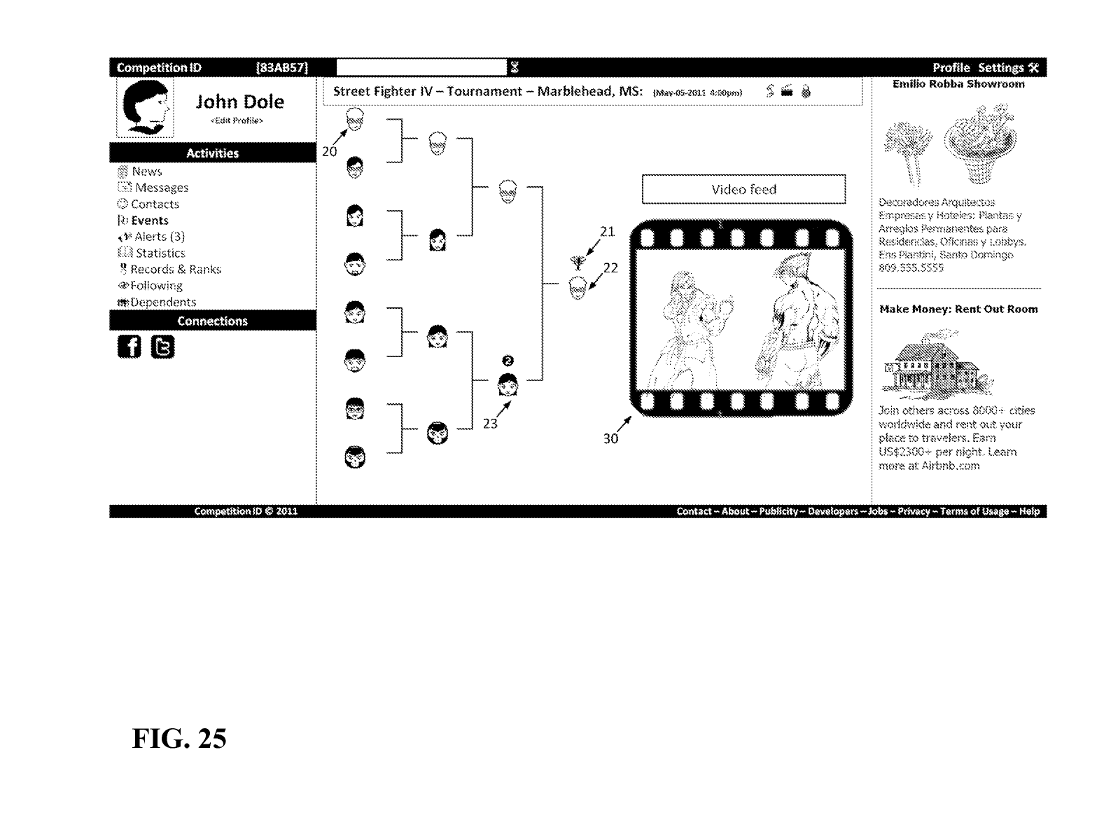

FIG. 17 shows an exemplary summary of statistics and awards by activity on a user profile. The list of activities is grouped by activity type such as: Board games 20, Video games 30 or Sports 40. Each group table 20, 30, 40 can contain specification columns such as:
a) Official 21: containing a total of won and lost events that were managed by an organization or company.
b) Unofficial 22: containing a total of won and lost events that were not managed by an organization or company.
c) Opposed 23: containing a total of won and lost event that are being verified by Arbiters FIG. 3:12 or Commissioner FIG. 3:13 users.
d) Total 24: containing a total of all won and lost events from previous columns.
e) Awards/Rank 25: containing one or more links of Ranks and Awards received FIG. 8.
f) Online 31: containing a total of won and lost online events.
g) Tournament 32: containing a total of won and lost tournament type events FIG. 25.
h) Lan-Party 33: containing a total of won and lost of Lan-Party videogame events.

All grouping definition and classification of statistics are managed by Administrator users FIG. 3:4 to maintain data consistency. Information presented in this screen is generated from the Statistics FIG. 4:7, Ranks FIG. 4:8 and Top Competitors FIG. 4:9 database entities and are presented as hyperlinks that can take the user to see more details if pressed.

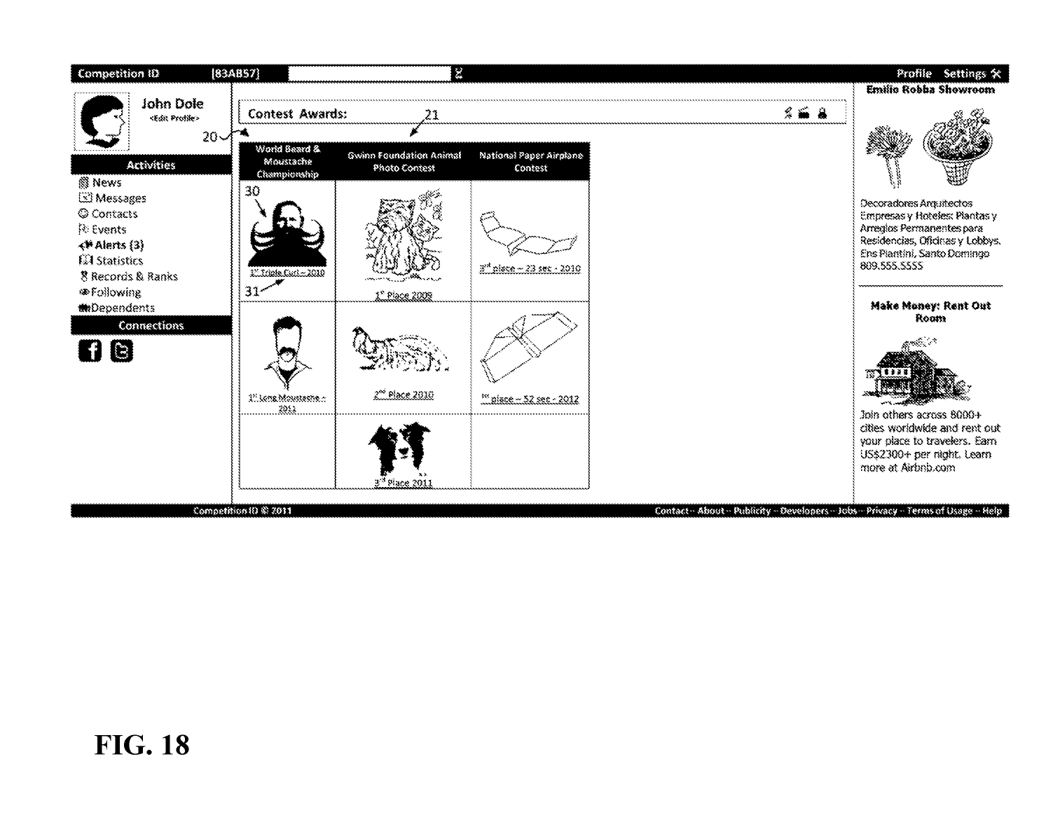

FIG. 18 shows an exemplary list of awards on a user profile. Awards shown in the Awards table 20 can contain a Picture 30 and a Hyperlink 31 that can take the user to see more details if pressed. If awards on consecutive years a Column with highlighted title 21 is shown and all related awards are arranged in the same column sorted by year.

FIG. 19 shows an exemplary list of dependent members FIG. 2:20-26 on a user profile. The dependent members are listed one for each cell in the Dependents table 20, each cell has the name of the dependent as a highlighted title 21 each describing cell can contain a Picture 30, along with one or more Hyperlinks 31 that can take the user to the dependent member profile FIG. 20 or see awards the dependent has received.

FIG. 20 shows an exemplary dependent member profile FIG. 2:21 on a user profile. Data is presented to be reviewed or changed in the Profile data 10, General information 20 and Additional info 30 sections. Those sections can have data types according to the Data types defined for each Activity FIG. 6 and additional data that the user can add as complement. The section can also contain links to the awards the dependent member has received. The structure of the Describing sections 10, 20, 30 can be as follows:
a) Main profile data 10: comprising of a title cell, a data cell and the profile picture. This section shows the data types defined by the creator of the activity FIG. 6 that apply to the dependent member and are data that the user must fill in order to participate in the Activity.
b) General information 20: comprising of a title cell and a detail cell. This table is a combination of user added data and generated competition results. The user can also add Pictures 21 and Links 22 that can connect to other dependent member profiles.
c) Additional info 30: comprising of a title cell and one or more detailing cells. This table is a combination of user added data and other data generated by the system. A list of past owners if any is also shown with cells containing the Picture 31 and a Link 32 with the name of the Past owners in case the dependent member has been sold or lent from other users. The link 32 can take the user to visit the profile of the past owner.

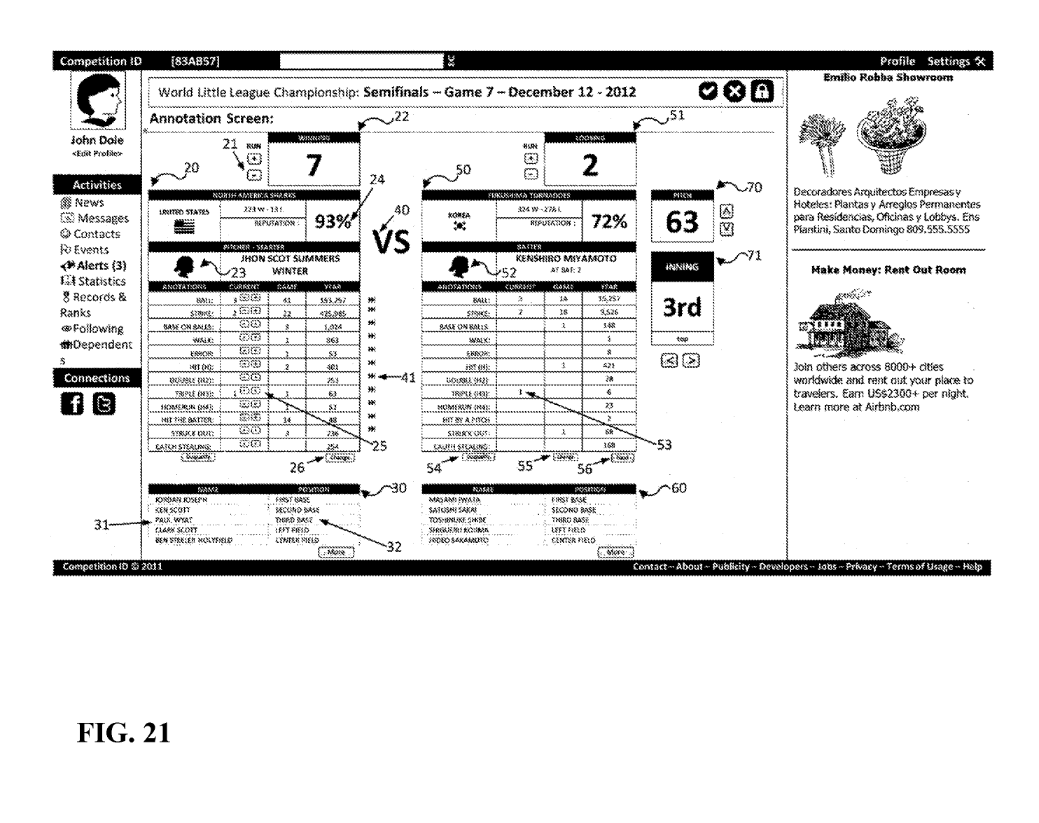

FIG. 21 shows an exemplary baseball annotation screen on a user profile. General data about the two competing teams 20, 50 are shown along with the reputation percentage 24. The “VS” 40 indicator shows the connection of the performing Pitcher 23 and the current Batter 52. Annotation tables are shown below each player description, those annotation tables have description columns such as:
a) Annotations: contains the name of the data field.
b) Current: contains plus (+) or minus (−) buttons which the user can press to increase or decrease the counters.
c) Game: contains the statistics of the current game which is the result of pressing the (+) or (−) buttons.
d) Year: contains the grand total of each data field for the current year.

Connector indicators 41 show the user that the incrementing of any data in the Pitcher table 20 is connected to the Batter table 50, therefore by incrementing the Triple [H3] 25 data field of the Pitcher table 20 is also incrementing the Triple [H3] field 53 in the Batter table 50.

There are other buttons the user can use to perform other operations such as:
a) Change 26, 55: used to register a player change.
b) Disqualify 54: used to disqualify a player.
c) Next 56: used to change the next batter in the lineup.

Active roster tables 30, 60 are also shown to let the Annotator FIG. 3:16 or Arbiter FIG. 3:12 user select players to change or disqualify. The Roster tables 30, 60 can have description columns describing the Name 31 and Position 32 of the players.

The annotation screen can have other annotation cell such as:
a) Run by team 22, 51: contains the runs for each team, the cell also has (+) and (−) annotation buttons and a highlighted title indicating which team is losing or winning
b) Pitch 70: containing the current pitch as a number and two arrow buttons that the user can use to increment or decrement the number.
c) Inning 71: containing three cells one with the “INNING” title, other with the Current inning and other with the indicator if is the Top or Bottom of the inning Two arrow buttons are shown below the cell which can be used by the user to increase or decrease the inning

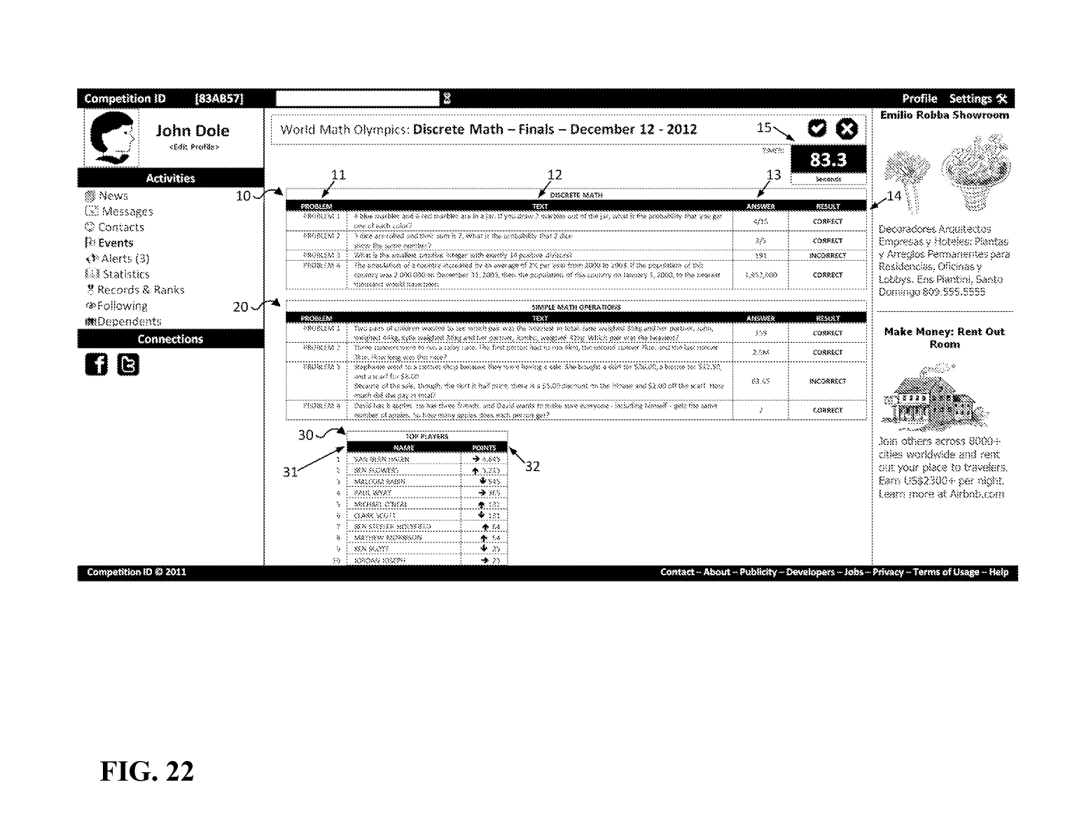

FIG. 22 shows an exemplary math tournament virtual event. In this event while a countdown timer 15 is still counting users can answer questions in the Discrete math 10 and the Simple math 20 tables. Both tables are filled questions set by Commissioners FIG. 3:13 or Sponsor FIG. 3:14 users. Both tables can comprise of columns such as:
a) Problem 11: containing the title of the problem.
b) Text 12: containing the text of the problem.
c) Answer 13: containing a field where the user can type the answer to the problem to be evaluated.
d) Result 14: containing a text indicator showing if the answer is correct or incorrect.

Also a Top players ladder table 30 is shown at the bottom. This table corresponds to a previously defined Top Competitor evaluation method FIG. 3:26, FIG. 4:9 for the Activity. The top players table is refreshed periodically and can have definition columns such as:
a) Name 31: containing the name of the player or Competitor
b) Points 32: containing a total of points gained by the Player or Competitor and an arrow indicating if he is ascending, descending or staying in the ladder. Arrows are colored blue if staying, green if ascending or red if descending.

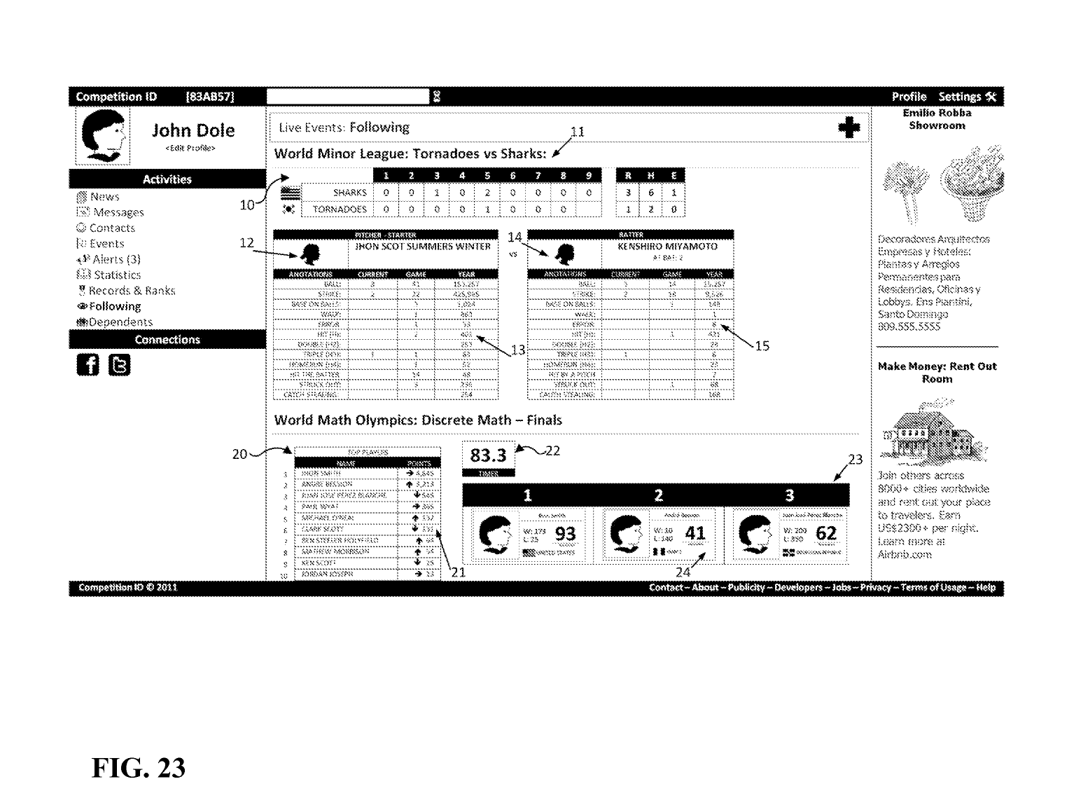

FIG. 23 shows the following of two distinct events on a user profile. In this example a user is following the results of a Baseball game 10, FIG. 21, and a Math tournament 2, FIG. 22. Each event has a Title 11 and a generated table 10, 20 with columns and cells containing data relevant to the each activity.

For the Baseball game the user can see the Runs by Inning table 10, also the Pitcher 12 and the Batter 14 tables containing numeric information 13, 15 that is updated as they are entered by Annotator users FIG. 21, FIG. 3:16.

For the Math tournament a Top players ladder table 20, FIG. 22:30, a Countdown timer 22 and a Top 3 competitors table 23 are shown. The top 3 competitors table 23 contains the Mini profiles 24, FIG. 14 of the players with the highest scores and is constantly updated during the event.

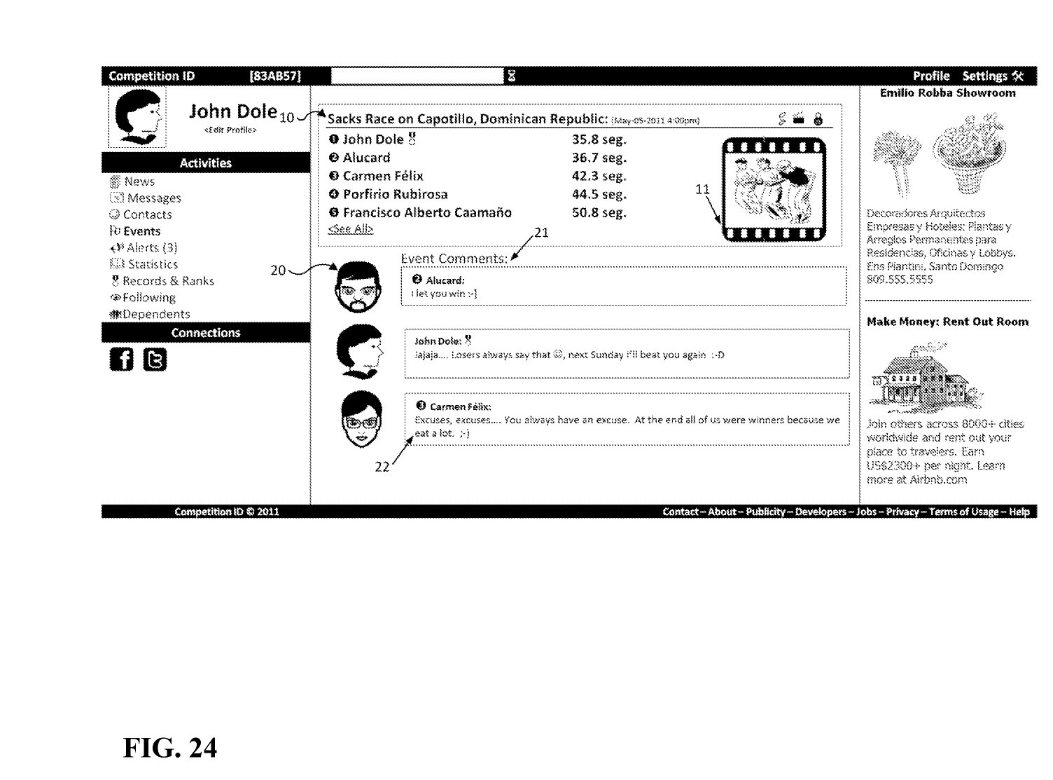

FIG. 24 shows the results of an exemplary Single event competition: A sack race. Results of the race are shown in the results table 10 with the names of the top winners along with a highlighted circle indicating their position in the race; the seconds they took to complete the race are shown in another column. A video section 11 is also shown where the user can watch the video of the race if any. A chat section 21 is also shown with text messages of the users about the race. The text section can contain a picture 20 and the text 22 for each message posted.

FIG. 25 shows an exemplary result of a single elimination videogame tournament. Here profile pictures of players are shown in a single elimination bracket 20 showing the winner with a cup icon 21 above his profile picture 22, the player who won second place is shown with his profile picture 23 and a highlighted circle with the number 2 above the profile picture 23. A Video section 30 is also shown where the user can watch videos of the tournament if any.

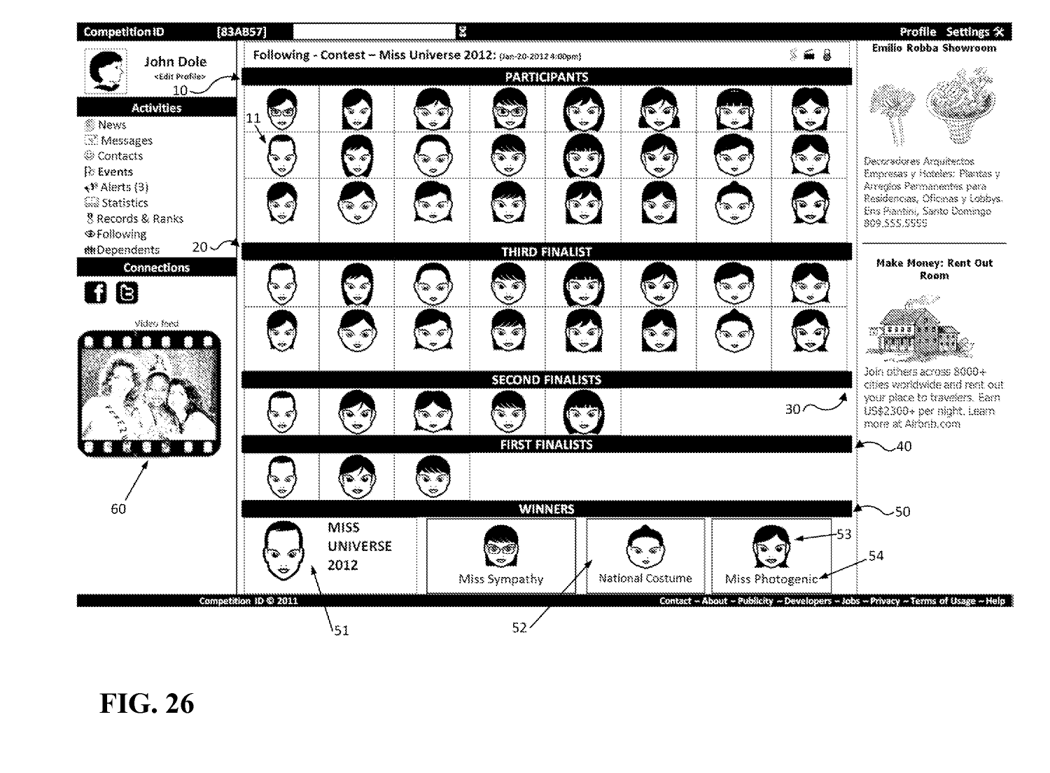

FIG. 26 shows the result of an exemplary beauty contest event. Here a picture profile for each competitor is shown in the Participants 10, Third finalist 20, Second finalist 30, First finalist 40 and Winners 50 tables. Winners table 50 have in a single colored cell 51 the profile picture shown in a bigger size than the competitors who won honor awards 52. Competitors who won honor awards are shown with their Profile picture 53 below the Award title 54. A Video section 60 is shown where the user can watch videos of the contest if any.

FIG. 27 shows the results of two exemplary round robin tournaments. Two tables show results for the Group A 10 and Group B 20 categories. The two tables show a Title 11 with the name of the group and the age range, a first column with Team names 12, a first name with Team names and a Total column 13, 21 with a total of all games won by each team. Other cell contains a 1 if the team won the game or a 0 if the team lost the event. A blocked dark cell for each cross section of the same team is also shown on each table to prevent the user for entering data of a team playing against itself

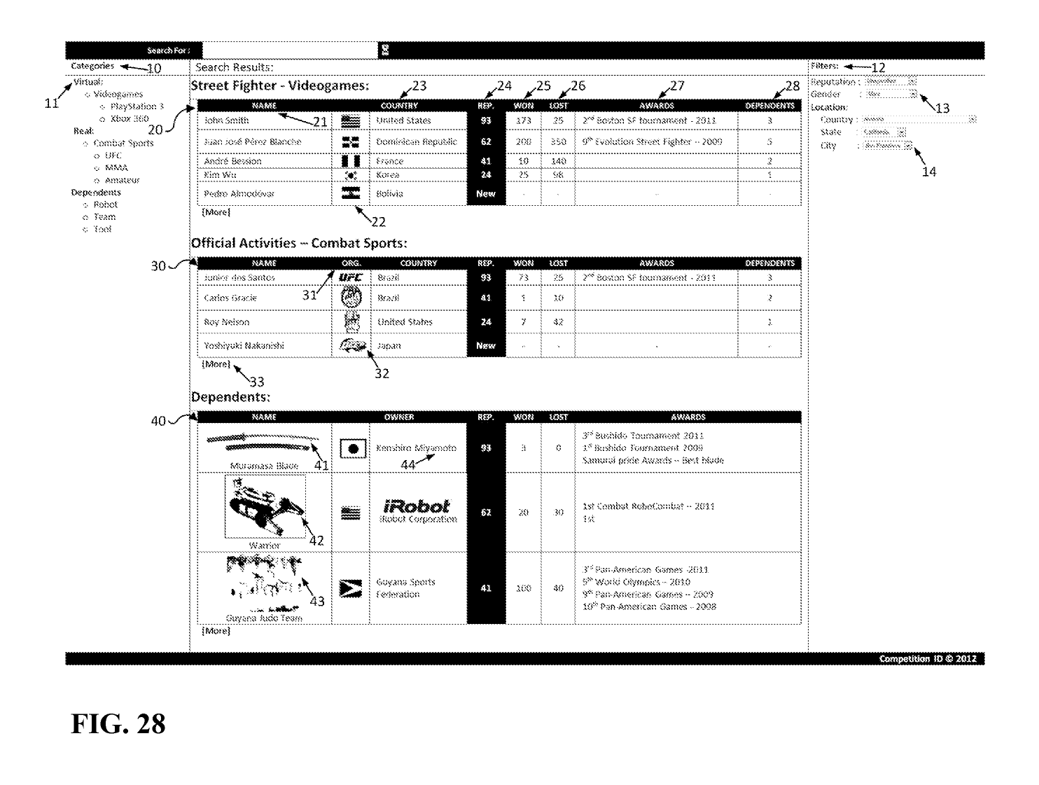

FIG. 28 shows an exemplary global search on the network. Once the user types the topic is searching in the Search bar 5 Results tables 20, 30, 40 are populated with each search with description columns such as:
a) Name 21: containing the name of the competitor, organization, dependent member, or user. This column can contain just a hyperlink with the name or a combination of a hyperlink with the name and a picture 41, 42, 43.
b) Country flag 22: containing a small flag picture.
c) Country 23: containing the country name.
d) Rep. 24: containing the reputation qualification FIG. 13 as a percentage number or an alphanumeric letter.
e) Won 25: containing a total of events won.
f) Lost 26: containing a total of events lost.
g) Awards 27: containing hyperlinks of awards and ranks FIG. 8.
h) Dependents 28: containing a total of dependent member profiles that the competitor has. FIG. 2, FIG. 19.
i) Owner 44: containing the name of the Owner if the element listed is a dependent member.
j) ORG. 31: containing a small logo 32 of the organization the competitor belongs.

Users can see more search results on each table by pressing one of the [More] hyperlink 33. Also the user can click on any category of the Categories column 10 to filter resulting tables 20, 30 40. More precision searches can be made by using the generated filters of the Filters column 12 such as: Gender 13 or City 14.

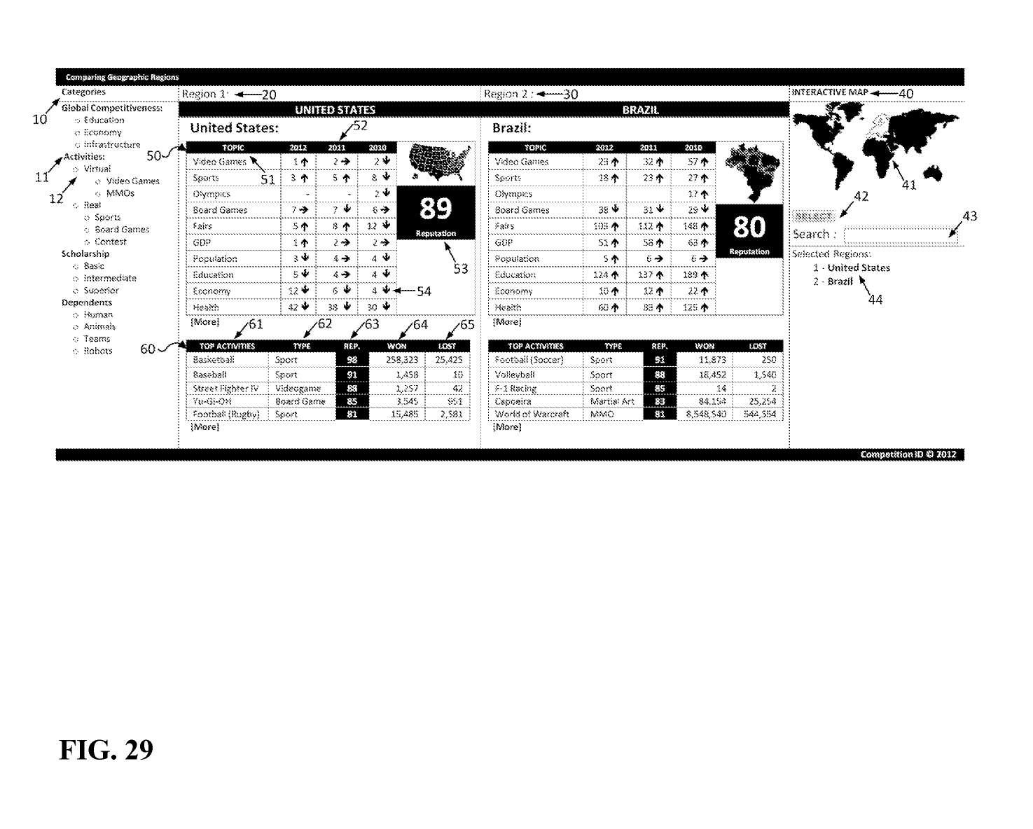

FIG. 29 shows an exemplary comparison between two geographic regions: USA vs. Brazil. To select the regions the user wants to compare the user can click in the interactive map 40 region showing a zoom capable map which the user can user to identify the region he wants to compare. After the user clicks and selects the region he can use the Select button 42 to add the selected geographic region to the Selected regions list 44. The user also has the option to search a specific region by typing directly in the Search field 43.

Once any geographic region 44 is selected, system generated categories are shown in the Categories column 10 with activities 11 and sub activities 12 the user can then click on any of those to filter the comparison. For each geographic region a Master comparison table 50 is shown. Those tables can have a Topic column 51 with the name of the activity and one or more dependent columns 52, one for each year of data. Cells on dependent columns 52 shows the rank of the geographic region representing by a number along with a colored arrow 54. This arrow 54 shows the changes in the rank from previous years and can be colored green if the region is going up in the rank, red if is going down or blue if have no change. Data sources for the Master comparison table 50 of geographic regions can be taken from the network or from other official sources.

A Top activities table 60 is also shown for each geographic region. Those tables can have description columns such as:
a) Top Activities 61: containing the name of the Activity FIG. 3:20.
b) Type 62: containing a classification of the Activity FIG. 3:20.
c) REP. 63: containing the Reputation qualification represented by a percentage number or an alphabetical letter. FIG. 13, FIG. 15.
d) Won 64: containing a total of events won.
e) Lost 65: containing a total of events lost.

Once the reputation is calculated from all the activities, a reputation qualification is shown on each Country cell 53, those cell can be comprise of a Mini map of the region and the reputation qualification represented as a number or letter.

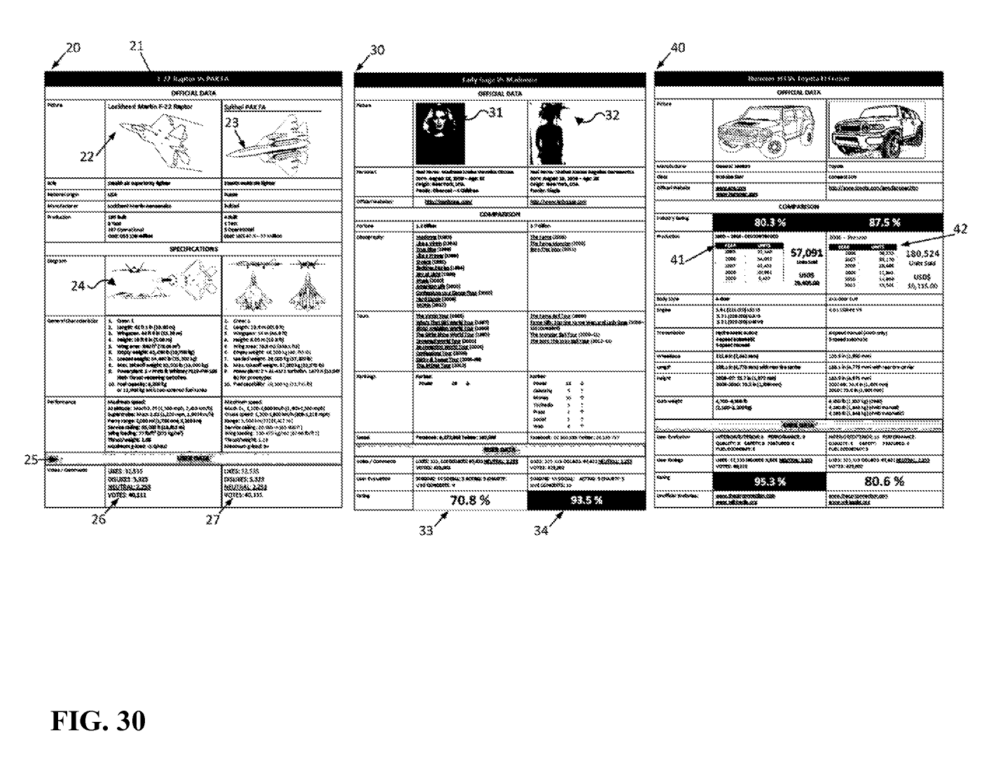

FIG. 30 shows three examples of comparisons that the user can do in the network: a Military aircraft 20, Celebrities 30 and Vehicles 40. The comparison engine can search and collect data from other sources on the internet to combine those with data produced in the network. The comparison engine can highlight automatically the topic where an element is better than the other based on predefined rules for each data. e.g.: for Speed of a vehicle the higher number is better.

Therefore for the first table 20 comparing the F-22 22 raptor vs. the PAK-FA 23 the comparison engine can highlight as green any specification obtained from official websites. The comparison columns also contain charts 24 or diagrams and the total of User votes 25 such as: Likes, Dislikes, Neutral and a Grand total of votes.

For the second table 30 comparing Celebrities 31, 32, the comparison engine can look for data from web sources like Forbes and can combine them with user votes in the network, this combination can be shown as reputation 33, 34.

The third table 40 comparing vehicles, the engine can look for official websites to receive technical data from the models, 41, 42 and combine with User votes to determine the reputation.

While the present invention has been described in connection with the preferred of the various Figs., it is to be understood that other similar embodiment may be used or modifications and additions may be made to the described embodiments for perform the same function of the present invention without deviating therefrom.

What is claim is:

1. A computer-implemented method, where users can perform operations comprising:
creating activities with one or more custom set of data types, rules, formulas and ranking systems definitions to mimic a virtual or live activity; or creating activities by modifying an existing set or rules, data types, formulas and ranking systems definitions as a template;
adding and maintaining data of all means they use to compete;
participating in competition events, having all data generated in said events on a centralized profile;
sending requests and invitations to events where a predefined set of rules will apply;
challenging one or more users, inviting them to events that will be certified by arbiters;
establishing competition based relationships;
sharing data and statistics;
following users, organizations, dependent members, events, or competition activities; or comparing network elements based on competition data and other sources.

2. The computer-implemented method cited in claim 1, further comprising a Human, Organization or Artificial intelligence that can login to perform one or more operations using one or more user roles.

3. User roles cited in claim 2, further comprising a set of privileges that are automatically assigned based on what the user does, or can be manually assigned by administrative personnel from the company who runs the network.

4. User roles cited in claim 2, further comprising the process of manually or automatically assigning a set of privileges based on operations that each user does in the network comprising:
commissioner: when creating an activity;
sponsor: when creating an activity and transferring control to another user;
competitor: when joining an activity or participating in one or more events;
follower: when subscribing to receive continuous updated information about one or more topics;
arbiter: when accepting a request to judge one or more events;
annotator: when accepting a request to enter or capture data of one or more events;
scout: when subscribing as a talent seeker; or
administrator: when manually been assigned as personnel of the company that runs the network.

5. Follower user role cited in claim 4, further comprising the right to do one or more operations comprising:
following one or more users, activities, organizations, or dependent members;
following one or more events of an activity;
joining activities to view statistics, rankings and top competitors;
comparing two or more elements of the network using the Comparison System as cited in claim 50; or
voting on polls, surveys or contests.

6. Competitor user role cited in claim 4, further comprising the right to do one or more operations comprising:
viewing statistics, rankings and top competitors of a given activity before joining;
joining a competition activity, team, organization or event;
participating in one or more events of any activity he joined;
viewing his statistics and reputation of activities he has participated in;
viewing and sharing his statistics and Top Competitors listings on an activity he joined;
sending requests to Commissioner users, asking them to impugn, review or disqualify events, competitors, data or arbiters; or
accepting or denying requests sent by other users such as: team, challenge or follow.

7. Arbiter user role cited in claim 4, further comprising accepting an arbiter request which give the user the right to do one or more operations on one or more events comprising:
sending requests to other users to invite them to the events he is judging;
approving, certifying or disqualifying data, competitors or rules of an event he accepted to be the arbiter;
disqualifying competitors and specific data before or after the event took place;
canceling or rescheduling competition events he is judging;
viewing statistics of events he judged or participated in;
viewing top competitors of an activity he has participated in; or
viewing the complete profiles of Competitor users attending to an event he is judging.

8. Annotator user role cited in claim 4, further comprising the right to do one or more operations comprising:
entering or capturing data on and event or;
correcting a mistake he made on the data entered before the data is certified by an arbiter.

9. Commissioner user role cited in claim 4, further comprising the right to do one or more operations comprising:
creating or changing competition activities with all related data such as: data types, rules, formulas or ranking systems;
accepting or denying one or more request to be the Commissioner of an activity sent by other users;
changing existing competition data types, rules and formulas;
scheduling, rescheduling, canceling or disqualifying an event;
approving subscriptions request to his activity sent by other users;
approving, certifying or impugning an event;
disqualifying competitors or arbiters attending to an event and all data related;
changing statistics definitions or creating new ones to view all data related to an activity he created or has been assigned to;
defining or changing the ranking system of an activity;
defining or changing the top competitor criteria of an activity he created or has be assigned to;
sending invitations to one or more competitors asking them to attend to one or more events of the activity he created or have been assigned to; or responding to dispute request made by users related to the activity he created or have been assigned to.

10. Sponsor user role cited in claim 4, further comprising the right to do one or more operations comprising:
creating or changing competition activities with all related data such as: data types, rules, formulas or ranking systems;
assigning the administration of the activity to another user;
viewing top competitors ranks and statistics of an activity he is sponsoring;
changing previously defined formulas of an activity he is sponsoring or creating new ones to calculate new statistics or view competition data the way he wants;
convening, scheduling rescheduling, or canceling competition events of an activity he is sponsoring;
viewing all events on a competition activity he is sponsoring; or
sending invitation request to competitor users, asking them to participate in one or more competition events he is sponsoring.

11. Scout user role cited in claim 4, further comprising the right to do one or more operations comprising:
sending scout request to Commissioners of competition activities to be able to follow and see all data related to the activities they're in charge;
creating formulas and reports to see competition data the way he wants; and
sending special requests and offers to talented users in the activities he was allowed to scout.

12. Administrator user role cited in claim 4, further comprising the right to do one or more operation comprising but not limited to:
maintaining all network information infrastructure elements such as servers, routers, cabling or databases;
resolving problems and correcting mistakes in the data; or
taking disciplinary actions against any element of the network that violates company policies.

13. Creating activities cited in claims 1 and 2, further comprising adding and arranging in a logical way a custom set of data types, formulas and predefined rules by users with the Commissioner or Sponsor user roles.

14. Arranging a set of data formulas in a logical way as cited in claim 13, further comprising manipulating a set of software predefined data types and the default rule that will apply to each one. Each data type can refer to previously created data element or can represent itself as a standalone element.

15. The default rule cited in claim 14, further comprising specifying predefined operators to enforce data validation comprising but not limited to:
numbers: designed to store positive or negative numeric data;
competitor type: designed to store the specification of a competitor type such as: human, organization, robot or dependent member;
event type: designed to store the event type definition such as: single event, round robin, single elimination tournament, double elimination tournament or contest;
time: designed to store numeric values related to time; or letters: designed to store alphanumeric characters.

16. Custom set of data types as cited in claim 13, further comprising adding data elements that can store data values with special meaning in the network.

17. Data elements with special meaning as cited in claim 16, further comprising one or more rules that govern the type of information that can be stored, comprising:
competitor type: containing the type of competitor such as: human, organization, team, animal, plant, vehicle, robot or tool;
event type: containing the type of the event such as: single event, single elimination tournament, double elimination tournament, round robin or contest;
event group: containing one or more event parts from a bigger event, such as: game, contest or tournament;
event part: containing one or more element of an event group such as: round, match, inning, quarter time or half time;
event duration: containing a value that defines the duration of an event or one of its parts;
arbiter rule: containing a specification that one or more arbiters must check, enforce or approve; or
counter: containing a numeric value designed to count one or more elements in a competition event.

18. Predefined rules as cited in claim 13, further comprising one or more software validation checks to ensure that data is entered correctly. Those validations comprise but are not limited to:
more than: indicating that more than the default number or quantity can be allowed;
less than: indicating that no more than the default number or quantity can be allowed;
arbiter check: specifying a data that one or more arbiters must manually check and approve;
single elimination: indicating that a competitor is out if loses once;
double elimination: indicating that a competitor is out if loses twice;
best of: indicating an evaluation of a group of events specified by a numeric value, the competitor with most wins of said group of events is the winner;
win: specifying a condition that determines the winner of an event. This condition can be numeric, alphanumeric, an arbiter check or a combination of them; or
lose: specifying a condition that determines the loser of an event. This condition can be numeric, alphanumeric, an arbiter check or a combination of them.

19. Adding all means user use to compete as cited in claim 1, further comprising adding and maintaining data for one or more secondary profiles containing the data about any mean competitors use to compete alongside them or in their name. Those secondary profiles known as dependent members profiles can accommodate any real or virtual element such as:
Human: living specie capable of logical reasoning, language and social learning.
Animal: any living specie except humans that can move from one place to another by its own means;
Plant: vegetative living being that cannot move by itself;
Robot: artificial intelligence attached to a physical device that can move by its own means;
Vehicle: mobile mechanism that can travel on land, water, air or outer space by its own means;
Tool: any physical item that can be used to achieve a goal and is not consumed in the process;
Gadget: a tool or machine that has a particular function, but is often thought of as a novelty; or
Team: a group of humans, animals or artificial intelligences linked in a common purpose.

20. Adding and maintaining data of one or more secondary profiles as cited in claim 19, further comprising the action adding custom data the user considers important to better identify the dependent member, this data is shown alongside with competition generated data in the network. The user can also transfer said secondary profile to another user with all of its custom data, achievements and statistics.

21. Participating in competition events as cited in claim 1, further comprising one or more users with the Arbiter, Competitor, or Annotator user roles to join one or more events and add data by interacting with the rules and formulas previously defined for that event. Or letting users with the Commissioner, Arbiter or Annotator role to enter data related to the performance of one or more Competitors in one or more events.

22. Participating in competition events as cited in claim 1, further comprising competitors being evaluated automatically by the Reputation system during one or more events or after said events.

23. The Reputation system as cited in claim 22, further comprising a service that qualifies users based on their competition data, the result of those calculations are expressed by a percentage number or an Alphanumeric character such as a letter.

24. Sending requests and invitations to events as cited in claim 1, further comprising sending a special message from a user with the Commissioner or Sponsor role to one or more users asking them to participate in one or more events.

25. The special message asking to participate in one or more events as cited in claim 24, wherein the receiving user can answer in several ways, including:
accept: the user is listed in the attender list of the event;
reject: the request is dismissed and the user no longer related to the event in any form;
maybe: the request is set to be responded on a later time; or report sender: The request is marked as spam or scam to an administrator user.

26. The Accept action as cited in claim 25, further comprising the privilege of viewing all relevant data about the activity and the specific event. Once accepting the invitation the user can also view the users that will compete against him in the event.

27. The Accept action as cited in claim 25, further comprising other operations that users can do before the event take place such as:
reject arbiter: the user do not accept being judged by the arbiter, in which case a rejection request is sent to the Commissioner of the activity;
propose another arbiter: the user specifies another user to be included as arbiter for the event;
propose another date: the user proposes another day for the event to take place; or
reject competitor: the user rejects a competitor, sending a check request to either the Arbiter or Commissioner of the activity.

28. Challenging other competitors as cited in claim 1, further comprising sending a special message from one Competitor user to one or more Competitor users asking them to compete in an event that will be judged by a proposed arbiter.

29. She special message asking to compete as cited in claim 28, wherein the receiving user can respond in several ways, including:
accept: the user is listed in the attenders list of the event;
reject: the request is dismissed and the user is not related to the event in any form;
maybe: the request is set to respond on a later time; or report sender: the user marks the request as spam or scam to an administrator user.

30. Establishing competition driven relationships as cited in claim 1, wherein are established automatically when users do operations in the network. Members of the network can have one or more relationship comprising but not limited to:
teammate: linking two or more members of the same team. The relation is assigned when members join a team and is lost when members leave the team or are expelled;
roommate: linking all members who check into the same room or habitation. The relation is lost when members leave the place;
mentor: linking a member with a team, organization or another member asking for help. The relationship is assigned when the member accepts to be the mentor of the team or organization; or when the mentor accepts a request asking for help from other member; The relationship is lost when the mentor leaves the team or organization or when either the member who asked for help or the mentor decides to terminate the helping period;
colleague: linking all mentors of the same organization or team. The relationship is assigned when the member accepts to be a mentor within the organization and is lost when the member leaves the organization or is expelled or demoted;
rival: linking two or more members that compete against each other on a regular basis. The relationship is assigned when the competition ratio between them increases and is lost when said competition ratio decreases in time;
opponent: linking two or more members who compete in an event. The relationship is assigned when the members confirm the participation in the event and is lost when the event ends; or
enemy: linking two or more robot or artificial intelligences members who compete against each other in events which involves the physical or virtual elimination of at least one of them. This relationship is assigned when the members join a virtual competition event, war simulation or videogame session and is lost when the virtual event, war simulation or videogame session ends. This relationship cannot be assigned to living beings.

31. Be elected as an arbiter as cited in claim 1, further comprising accepting one or more requests to judge one or more events. A user can be elected as an arbiter by the user who created the event or sent a challenge request cited in claim 28. After accepting an arbiter request the accepting user gains some control over the event he is judging and can perform one or more operations comprising:
review: action of Viewing all profiles and statistics of competitors attending;
disqualify: action of disqualifying a competitor or dependent member voiding all data gained;
reschedule: action of setting the event to take place in another moment, day, month or year; or
approve: accept and certify data previously entered by him or other users.

32. Share as cited in claim 1, further comprising sending information to other networks to be viewed and commented by users of said networks such as: social networks, business networks, or student networks. Information that can be shared to other networks comprises but is not limited to Ranks, Achievements, Event results, Dependent member data or Announcements.

33. The Following action as cited in claim 1, wherein a user adds one or more element of the network to receive updated information about them in his profile. Those elements of the network comprise but are not limited to: Users, Organizations, Teams, Dependent members, Events or Activities. The user can also choose the time period in which this information is updated and sent to his profile. Said time periods comprises but are not limited to seconds, minutes, hours, years, weeks or years.

34. The Comparing action as cited in claim 1, further comprising adding two or more elements of the network to a virtual computational space to view automatically computed comparisons of each one versus the others.

35. Automatically computed comparisons as cited in claim 49, further comprising calculating which element is better than the others based on data collected in the network and other external sources. Said calculations take place when computing both the data and the Which is better rule.

36. The Which is better rule cited in claim 50, further comprising analyzing a special declaration attached to each data element that instructs the computation system to choose as winner one or more comparing elements. Said special declarations comprising but not limited to:
more: a higher numerical value is better;
less: a lower numerical value is better;
before: an earlier time value is better;
after: a later time value is better; or
value: a specific numeric or alphanumeric value is better.

37. A distributed computer system that provides a service to users using one or more connected devices over a network to perform a method comprising:
receiving and storing information about competition or recreational activities;
generating consolidated user profiles for each user and his dependent members cited in claim 19, having all data the user generates or is interested to in said virtual spaces;
generating Mini profiles showing basic competitive information and reputation;
providing a search infrastructure based on competition data;
providing a user interface for comparison of two or more elements of the network based on competition data and other external sources as cited in claim 34;
providing a user interface for the creation or administration of one or more activities as cited in claims 13 to 18;
providing a user interface for adding and maintaining dependent member profiles of one or more non-user mean used to compete in events, as mentioned in claim 19;
providing a user for sending and receiving one or more requests as cited in claims 24 to 27;
providing and interface allowing users to share or send statistics and achievements to other networks, as cited in claim 32;
providing a user interface to receive updated information of other elements of the network a user is following, as cited in claim 33;
providing a user interface to manage one or more challenge request as cited in claims 26 and 27; and
providing a user interface to manage one or more Arbiter request as cited in claim 31.

38. The distributed computer system cited in claim 37, further comprising one or more server farms, a connection mean such as the internet and connected devices.

39. Server farms as cited in claim 38, further comprising one or more physical locations in which one or more servers can be installed and connected to the connection mean cited in claim 53.

40. Servers as cited in claim 39, further comprising a computer machine with processor, a memory and an being programmed via executable program instructions to run one or more services or receive, store or retrieve data from storage means, process said data at a user request and send the results back to the user using a connection mean accomplishing specific functions comprising:
web servers: sending and receiving information using web standard ports and protocols;
database servers: storing and retrieving information on one or more databases stored into one or more memory devices such as disks, random access memory modules or solid state drives;
application servers: retrieving data from database servers, making some calculations and send the data back to requested connection devices with high computing power such as computers or videogame consoles;
mobile app servers: retrieving data from database servers, making all calculations and send the data back to applications running on mobile devices or devices with low computation power such as: smartphones, portable videogame consoles or smart TVs;
firewall servers: filtering unauthorized access to users not accessing the services using the correct ports; or
load balancing servers: redirecting information flow ensuring that all servers doing the same function have the same workload.

41. The internet connected devices as cited in claim 38, further comprising devices that can connect to the server farm using a network mean also cited in claim 38, to perform operations or send and receive information, said devices comprising but not limited to:
personal computer: computing device comprising a processor and a memory whose it size makes it useful for individuals to be operated on a desk or table;
laptop: device comprising of a processor, a screen and a memory whose it size make it useful for individuals to be carried and operated in many environments;
tablet device: one piece computer device with a processor and a memory primarily operated by a touch screen whose it size makes it useful for users to operate them in any environment;
smartphone: mobile device with advanced computer capabilities whose wide range of functions make them useful for users to use them as a substitute for several other electronic devices such as mobile phones, mp3 players, digital agendas, calculators, personal digital assistants, digital cameras, video cameras, PC web browsers or GPS navigators;
home videogame console: interactive computer or customized computer system with can be used with a display device such a TV or monitor to display a game;
portable videogame: electronic device with a built-in screen, game controls, speakers and a battery whose main purpose is to display a game;
robot: mechanical apparatus comprised of electromechanical parts guided by a computer program or electronic circuitry; or
smart television: network connected hybrid television whose it primarily design is to display on demand video, run internet connected apps or surf the web.

42. Receiving and storing information as cited in claim 37, further comprising specialized software which can reside on one or more servers to perform operations comprising but not limited to:
providing a user interface to users for the definition of one or more activities as cited in claims 13 to 19;
providing a user interface to users for adding dependent member profiles as cited in claims 19 to 20;
providing a user interface to users for participating in one or more competition events as cited in claims 21 to 22;
providing a user interface to users for sending one or more invitations to one or more events as cited in claims 25 to 27;
providing a user interface to users for sending one or more challenge request as cited in claim 29;
providing a service for automatically assigning competition driven relationships as cited in claim 30;
providing a user interface for users to manage arbiter request as cited in claim 31;
providing a user interface for users to share information as cited in claim 32;
providing an interface for users to follow other elements of the network as cited in claim 33; or
providing an interface for automatically comparing two elements of the network as cited in claim 35.

43. Generating a consolidated user profile as cited in claim 37, further comprising a centralized virtual space in which users can perform operations and have all data related to competition activities, dependent members or updates about elements of the network they are following.

44. The Centralized virtual space cited in claim 43, further comprising the result of one or more dynamic calculations from various database sources along with text or picture hyperlinks that enables the user to perform one or more operations when pressed.

45. Database sources as cited in claim 44, further comprising database entities located on one or more database servers storing data and rules comprising but not limited to:
activity: storing basic activity definition and rules such as: title, subtitle, logo, class, type, age range, or supporting company logo;
competition data: storing custom data types, links to other data types and default rules;
formula: storing operators and calculations steps declared and linked to previous declared custom data types;
event: storing each occurrence of an activity with all custom data types, formulas, rules and information filled by the users;
statistics: storing one or more results of one or more calculations using formulas created in the Formula database entity and applying them to the data instances stored in the events database entity;
ranks: storing one or more rules or goals that competitors must meet to be rewarded; or top competitors: storing one or more rules to select and reward the best competitors and the period of time rewards will remain.

46. Generating Mini profiles as cited in claim 37, further comprising automatically generating a portion of the screen containing basic information such as profile picture, title, name, last name or country along with other periodically calculated results.

47. Periodically calculated results as cited in claim 46, comprising but not limited to events won, events lost, total of events, new indicator, reputation percentage, reputation letter.

48. The portion of the screen as cited in claim 46, further comprising a background frame that is filled with color according to the reputation percentage or reputation letter cited in claim 47, background color according to reputation result comprise but is not limited to:
red: for a percentage from 0 to 39 or letter D;
yellow: for a percentage from 40 to 59 or letter C;
orange: for a percentage from 60 to 89 or letter B; or green: for a percentage from 90 to 100 or letter A.

49. Search infrastructure as cited in claim 37, further comprising specialized software routines and dynamically generated filters and categories allowing one or more users to find another elements of the network.

50. The dynamically generated filters cited in claim 49 further comprising one or more lists that are generated and showed in concordance to elements the user is searching for. After being generated by the system said filters can then be used by the user to limit the results of his search.
